(19) United States
(12) Patent Application Publication
(10) Pub. No.: US 2019/0196842 A1
(43) Pub. Date: Jun. 27, 2019

(54) MEDIUM, CHANGE DETECTION METHOD, AND CHANGE DETECTION APPARATUS

(71) Applicant: FUJITSU LIMITED, Kawasaki-shi (JP)

(72) Inventor: TOMONARI HORIKOSHI, Yokohama (JP)

(73) Assignee: FUJITSU LIMITED, Kawasaki-sh (JP)

(21) Appl. No.: 16/210,016

(22) Filed: Dec. 5, 2018

(30) Foreign Application Priority Data
Dec. 26, 2017 (JP) 2017-250076

(51) Int. Cl. G06F 9/44; G06F 21/57; G06F 9/50; G06F 21/62

(52) U.S. Cl. CPC G06F 9/44; G06F 21/57; G06F 2221/033; G06F 21/62; G06F 9/5055

(57) ABSTRACT

A medium having stored therein a program for causing a computer to execute a process below, the process includes receiving, from a second device, a request to a first device for utilizing a function provided via a network, acquiring information on a latest version of the function from a device that provides information on the function, determining whether a version of the function extracted from the request matches the latest version, when the extracted version does not match the latest version, transmitting a trial request in which the request is modified so as to utilize the function of the latest version, to the first device, and determining whether or not there is compatibility between the version of the function to be utilized by the request and the latest version based on a response to the trial request.

### CROSS-REFERENCE TO RELATED APPLICATION

This application is based upon and claims the benefit of priority of the prior Japanese Patent Application No. 2017-250076, filed on Dec. 26, 2017, the entire contents of which are incorporated herein by reference.

### FIELD

The embodiments discussed herein are related to a medium, a change detection method, and a change detection apparatus.

### BACKGROUND

A web application programming interface (WebAPI) provided by a third party is utilized to collect information, and to provide additional services, in some cases.

When a third party upgrades the version of a WebAPI, a notification of the upgrade is normally not sent to individual users. An article of the notification is commonly published on a site on which information on the WebAPI is provided to the public.

Accordingly, if a user of the WebAPI does not notice the article of the notification, the user may update the WebAPI to the new version with a delay. Whether the user is required to update the WebAPI to the new version in the system differs depending on the extent of the modification in the new version.

Related techniques are disclosed in, for example, Japanese National Publication of International Patent Application Nos. 2013-516715 and 2011-525013, and Japanese Laid-open Patent Publication No. 2013-164879.

### SUMMARY

According to an aspect of the embodiments, a medium having stored therein a program for causing a computer to execute a process below, the process includes receiving, from a second device, a request to a first device for utilizing a function provided via a network, acquiring information on a latest version of the function from a device that provides information on the function, determining whether a version of the function extracted from the request matches the latest version, when the extracted version does not match the latest version, transmitting a trial request in which the request is modified so as to utilize the function of the latest version, to the first device, and determining whether or not there is compatibility between the version of the function to be utilized by the request and the latest version based on a response to the trial request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a network configuration example;

FIG. 2 is a diagram illustrating a module configuration example of an API usage program;

FIG. 3 is a diagram illustrating a usage example of a WebAPI;

FIG. 4 is a diagram illustrating a trial example of the latest version;

FIG. 5 is a diagram illustrating an operation example of the latest version;

FIG. 6 is a diagram illustrating a trouble example with a provision end;

FIG. 7 is a diagram illustrating an overview of version inspection according to a first embodiment;

FIG. 8 is a diagram illustrating an overview of compatibility inspection in the first embodiment;

FIG. 9A is a diagram illustrating a module configuration example of a relay device;

FIG. 9B is a diagram illustrating a module configuration example of a compatibility inspecting unit;

FIG. 10 is a diagram illustrating an example of a system table;

FIG. 11 is a diagram illustrating an example of an identifier format table;

FIG. 12A is a diagram illustrating a first example of an inspection result table;

FIG. 12B is a diagram illustrating the first example of the inspection result table;

FIG. 13 is a diagram illustrating a second example of the inspection result table;

FIG. 14 is a diagram illustrating a registration processing flow;

FIG. 15 is a diagram illustrating a specification processing flow of a version designation scheme;

FIG. 16 is a diagram illustrating a main processing flow;

FIG. 17 is a diagram illustrating a latest version specification processing flow;

FIG. 18A is a diagram illustrating an example of a Web page of an information disclosure server;

FIG. 18B is a diagram illustrating an example of the Web page of the information disclosure server;

FIG. 19 is a diagram illustrating an extraction processing flow of a latest version identifier;

FIG. 20 is a diagram illustrating a compatibility inspection processing flow;

FIG. 21 is a diagram illustrating the compatibility inspection processing flow;

FIG. 22 is a diagram illustrating the compatibility inspection processing flow;

FIG. 23 is a diagram illustrating a trial request generation processing flow;

FIG. 24 is a diagram illustrating a compatibility determination processing flow;

FIG. 25A is a diagram illustrating an example of an operation response and a trial response;

FIG. 25B is a diagram illustrating an example of the operation response and the trial response;

FIG. 25C is a diagram illustrating an example of the operation response and the trial response;

FIG. 25D is a diagram illustrating an example of the operation response and the trial response;

FIG. 25E is a diagram illustrating an example of the operation response and the trial response;

FIG. 25F is a diagram illustrating an example of the operation response and the trial response;

FIG. 26 is a diagram illustrating the compatibility inspection processing flow;

FIG. 27 is a diagram illustrating an example of a notification screen;

FIG. 28 is a diagram illustrating an overview of version inspection according to a second embodiment;

FIG. 29 is a diagram illustrating an overview of compatibility inspection in the second embodiment;

FIG. 30 is a function block diagram of a computer; and

FIG. 31 is a function block diagram of a computer.

### DESCRIPTION OF EMBODIMENTS

In an aspect, an object is to detect a specification change that requires an attention in terms of a function provided via a network.

### First Embodiment

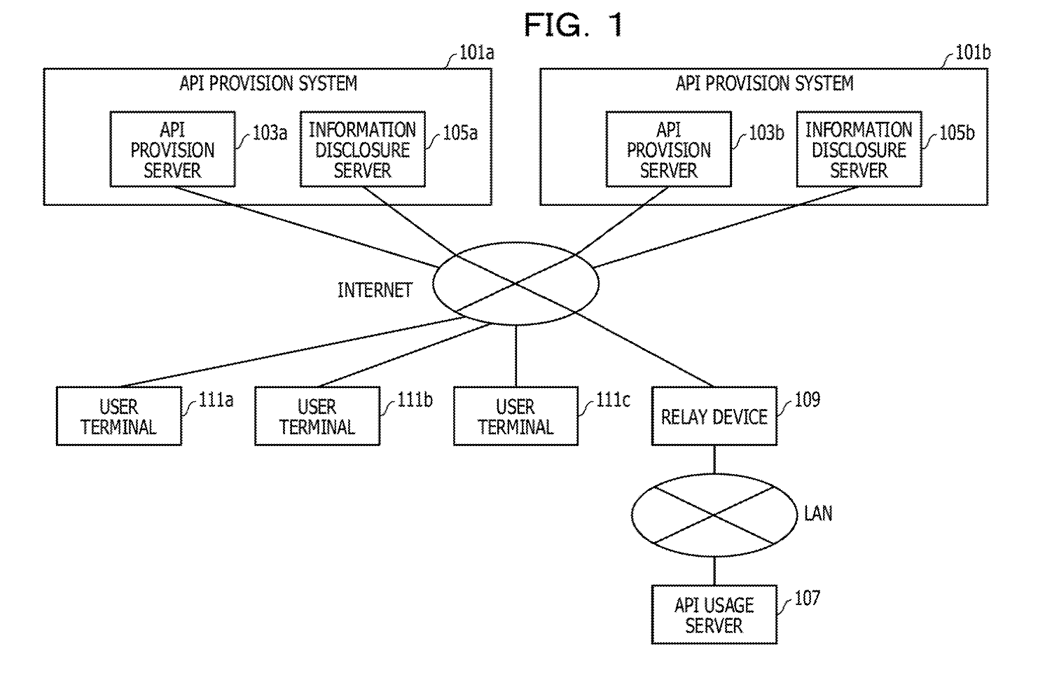

FIG. 1 illustrates a network configuration example. An API provision system 101a that is used by a person who provides service of a first WebAPI includes therein an API provision server 103a and an information disclosure server 105a. The API provision server 103a is coupled to the Internet, and provides the service of the first WebAPI via the Internet. The information disclosure server 105a is coupled to the Internet, and releases information on the first WebAPI via the Internet.

An API provision system 101b that is used by a person who provides service of a second WebAPI includes therein an API provision server 103b and an information disclosure server 105b. The API provision server 103b is coupled to the Internet, and provides the service of the second WebAPI via the Internet. The information disclosure server 105b is coupled to the Internet, and releases information on the second WebAPI via the Internet.

An API usage server 107 provides users with integrated service that utilizes the first WebAPI and the second WebAPI. The API usage server 107 is coupled to the Internet via a local area network (LAN) and a relay device 109. The relay device 109 is, for example, a gateway or a router.

User terminals 111a to 111c access the API usage server 107 via the Internet to utilize the integrated service.

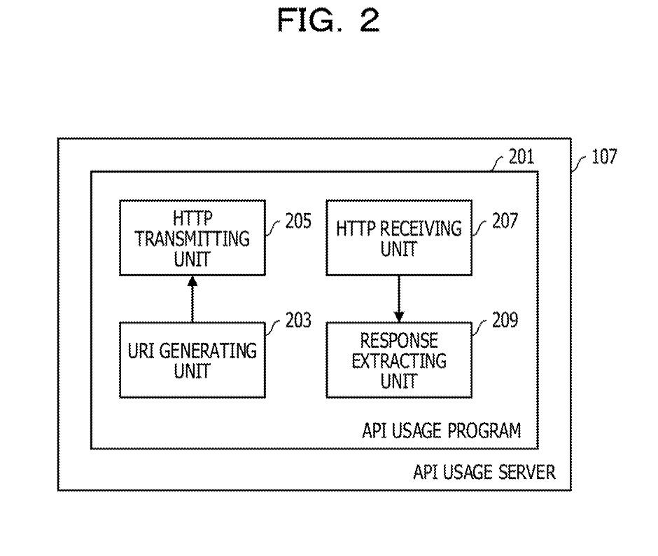

FIG. 2 illustrates a module configuration example of an API usage program 201 included in the API usage server 107. The API usage program 201 includes a uniform resource identifier (URI) generating unit 203, a hypertext transfer protocol (HTTP) transmitting unit 205, an HTTP receiving unit 207, and a response extracting unit 209.

The URI generating unit 203 generates a URI for calling a WebAPI. Based on an example of a URI “http://api.store.co.jp/v1/xxx/100?key=1234&code=1” for calling a first WebAPI, a configuration of the URI for calling the WebAPI will be explained.

The “http” indicates a scheme. The “api.store.co.jp” is a host name that specifies an access destination, and corresponds to a name (domain name) of the API provision server 103a that provides the first WebAPI. The “v1/xxx/100” is a path name, and includes elements separated with forward slash marks. The first element “v1” in this example corresponds to a version identifier of the first WebAPI. The second element “xxx” in this example corresponds to a type of a function in the first WebAPI. The third element “100” in this example corresponds to a number of data serving as an object.

The parameter “key=1234” of the URI is a key for utilizing the first WebAPI. The key for utilizing the first WebAPI is used for specifying the first WebAPI, and for designating a mode in the WebAPI. In this example, it is assumed that two types of keys are allocated to one usage device by distinguishing an operation mode in which the first WebAPI is actually utilized based on genuine data from a trial mode that is used for checking an operation of the first WebAPI based on pseudo data. Note that, “key=1234” is a key when the API usage server 107 designates the operation mode. Hereinafter, a key when the operation mode is designated is referred to as an operational key. On the other hand, a key when the trial mode is designated is referred to as a trial key.

The parameter “code=1” of the URI corresponds to an input parameter in the function of the first WebAPI.

Note that, the definitions about the path name and the parameter of the URI are arbitrary, and are commonly different depending on the WebAPI. Note that, in this example, it is assumed that a version identifier of the WebAPI is specified by any element included in the path name.

The HTTP transmitting unit 205 converts a URI for calling a WebAPI into an HTTP request, and transmits the HTTP request to the relay device 109 via the Internet. Processing to convert the URI into the HTTP request is performed based on the related art.

The HTTP receiving unit 207 receives an HTTP response to the transmitted HTTP request. The response extracting unit 209 extracts a status and a content of a response from the received HTTP response. The content of a response corresponds to return data from the WebAPI. The response extracting unit 209 performs processing for implementing integrated service, based on the status and the content of the response.

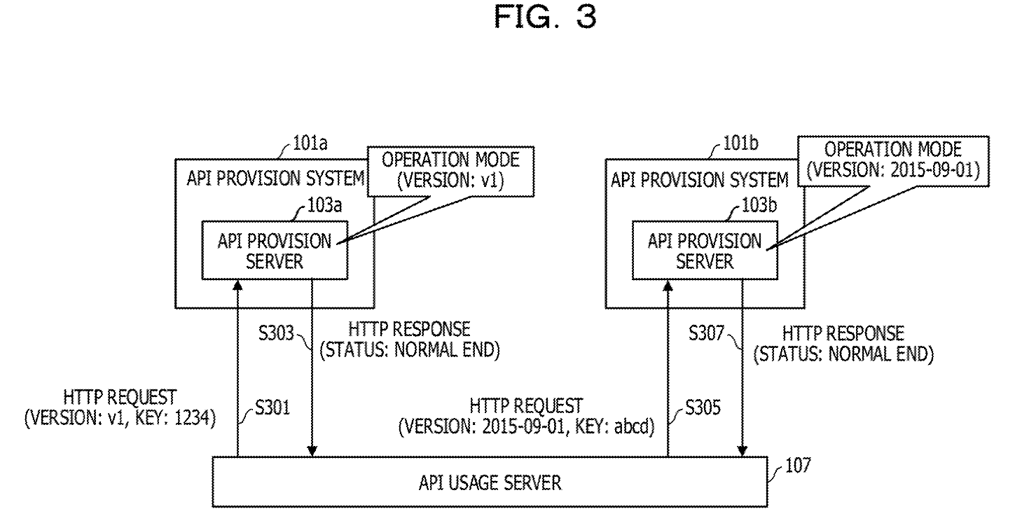

Subsequently, a general aspect in which a plurality of WebAPIs are utilized will be explained. FIG. 3 illustrates an example in which the API usage server 107 utilizes the first WebAPI of a version: v1 provided by the API provision system 101a in the operation mode, and utilizes the second WebAPI of a version: 2015-09-01 provided by the API provision system 101b in the operation mode. Note that, in the second WebAPI, versions are distinguished by identifiers of a date format.

In this example, the API usage server 107 transmits an HTTP request in which a name, a version identifier: v1, and a key: 1234 of the API provision server 103a are stored (S301).

The API provision server 103a having received the HTTP request performs processing of the first WebAPI of the version: v1 in the operation mode, and transmits an HTTP response in which return data and a status: normal end obtained by the processing are stored, to the API usage server 107 that is a sender of the HTTP request (S303).

The API usage server 107 transmits an HTTP request in which a name, a version identifier: 2015-09-01, and a key: abcd of the API provision server 103b are stored (S305). The “abcd” is a key when the API usage server 107 designates the operation mode.

The API provision server 103b having received the HTTP request performs processing of the second WebAPI of the version: 2015-09-01 in the operation mode, and transmits an HTTP response in which return data and a status: normal end obtained by the processing are stored, to the API usage server 107 that is a sender of the HTTP request (S307). With the procedure in the foregoing, the API usage server 107 operates normally.

Next, it is assumed that one of the WebAPIs is upgraded. For example, when the first WebAPI is upgraded, an article including information on a new version: v2 appears on a Web page of the information disclosure server 105a. An administrator of the API usage server 107 sees the Web page of the information disclosure server 105a, and knows that the first WebAPI has been upgraded. The administrator checks information on the first WebAPI of the new version: v2 and takes countermeasures.

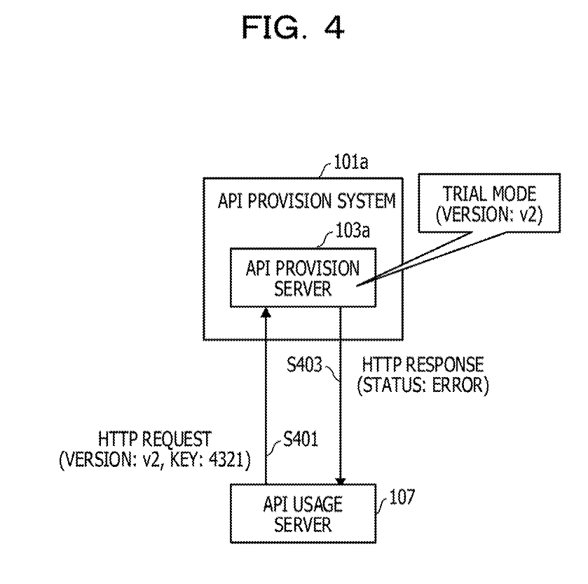

The administrator performs a test to call the first WebAPI of the new version; v2 in the trial mode, as illustrated in FIG. 4, in order to check an operation by the first WebAPI of the new version: v2.

In this example, the API usage server 107 transmits an HTTP request in which a name, a version identifier: v2, and a key: 4321 of the API provision server 103a are stored (S401). The “4321” is a key when the API usage server 107 designates the trial mode.

The API provision server 103a having received the HTTP request performs processing of the first WebAPI of the version: v2 in the trial mode. For example, when the API usage program 201 being utilized is operated without any change despite the incompatibility between the first WebAPI of the version: v2 and the first WebAPI of the version: v1, the processing of the WebAPI may be failed in some cases. In that case, an HTTP response in which a status: error is stored is transmitted to the API usage server 107 that is a sender of the HTTP request (S403).

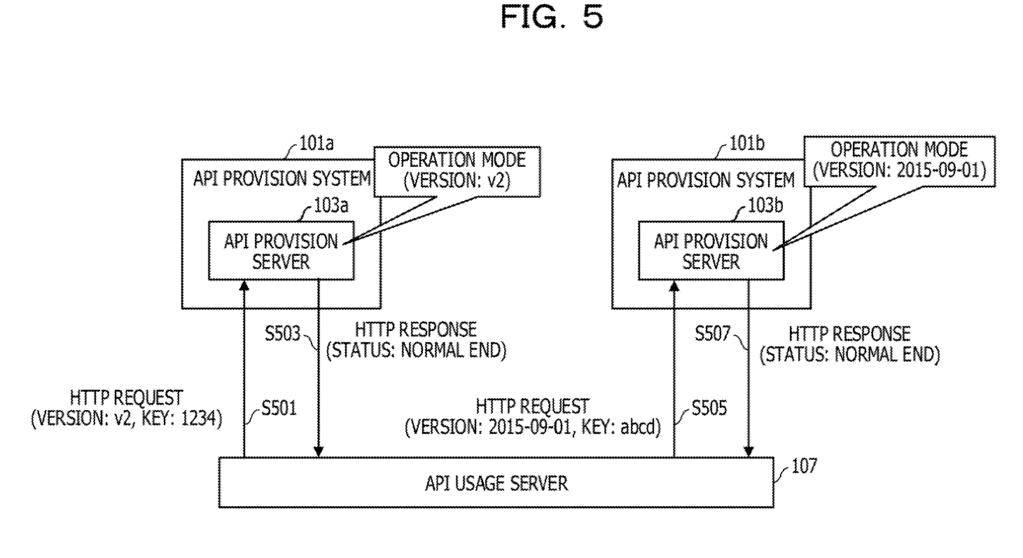

An operation in a case where the API usage program 201 is so as to utilize the first WebAPI of the version: v2 will be explained using FIG. 5.

In this example, the API usage server 107 transmits an HTTP request in which a name, a version identifier: v2, and a key: 1234 of the API provision server 103a are stored (S501).

The API provision server 103a having received the HTTP request performs processing of the first WebAPI of the version: v2 in the operation mode, and transmits an HTTP response in which return data and a status: normal end obtained by the processing are stored, to the API usage server 107 that is a sender of the HTTP request (S503).

Similar to the case of S305 illustrated in FIG. 3, the API usage server 107 transmits an HTTP request in which a name, a version identifier: 2015-09-01, and a key: abcd of the API provision server 103b are stored (S505).

As in the case of S305 illustrated in FIG. 3, the API provision server 103b having received the HTTP request performs processing of the second WebAPI of the version: 2015-09-01 in the operation mode, and transmits an HTTP response in which return data and a status: normal end obtained by the processing are stored, to the API usage server 107 that is a sender of the HTTP request (S507). By coping with the upgrade in this manner, the API usage server 107 operates normally.

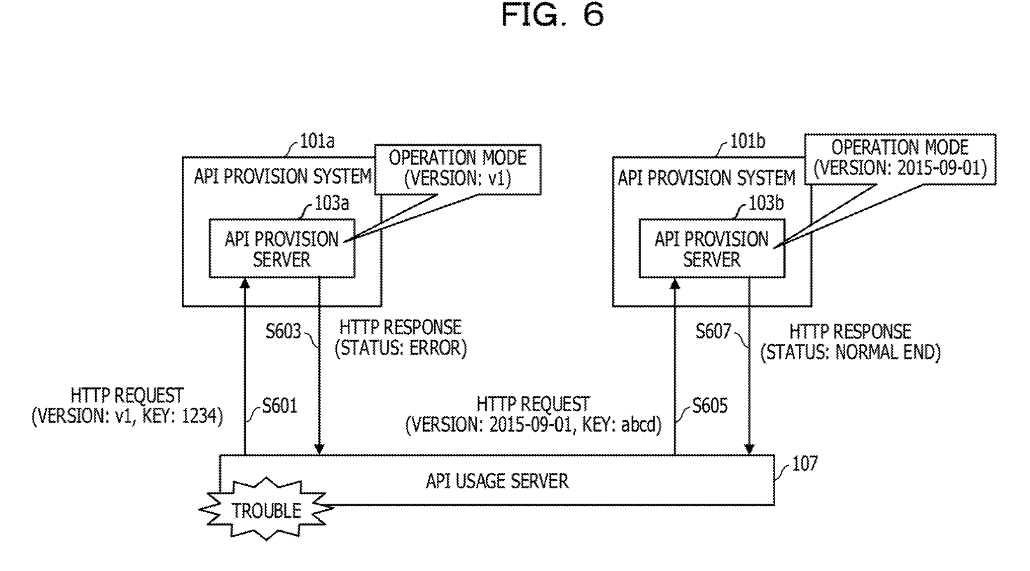

Note that, when the version being utilized is left without coping with the upgrade, and provision of the WebAPI of the version being utilized is ended in the API usage server 107, a trouble in the API usage server 107 may occur in some cases. FIG. 6 illustrates an example in a case where provision of the WebAPI of the previous version is ended.

In this example, similar to the case of S301 illustrated in FIG. 3, the API usage server 107 transmits an HTTP request in which a name, a version identifier: v1, and a key: 1234 of the API provision server 103a are stored (S601).

If the provision of the first WebAPI of the version: v1 is ended at the time when the API provision server 103a receives the HTTP request, the API provision server 103a does not perform the processing of the first WebAPI of the version: v1. In that case, an HTTP response in which a status: error is stored is transmitted to the API usage server 107 that is a sender of the HTTP request (S603).

As a result, the API usage program 201 of the API usage server 107 does not operate adequately. Note that, the procedures at S605 and S607 are similar to those in the case of S305 and S307 illustrated in FIG. 3.

In the present embodiment, in order to reduce an attention burden to an administrator of a system that utilizes the WebAPI, an upgrade in the WebAPI is monitored in the relay device 109.

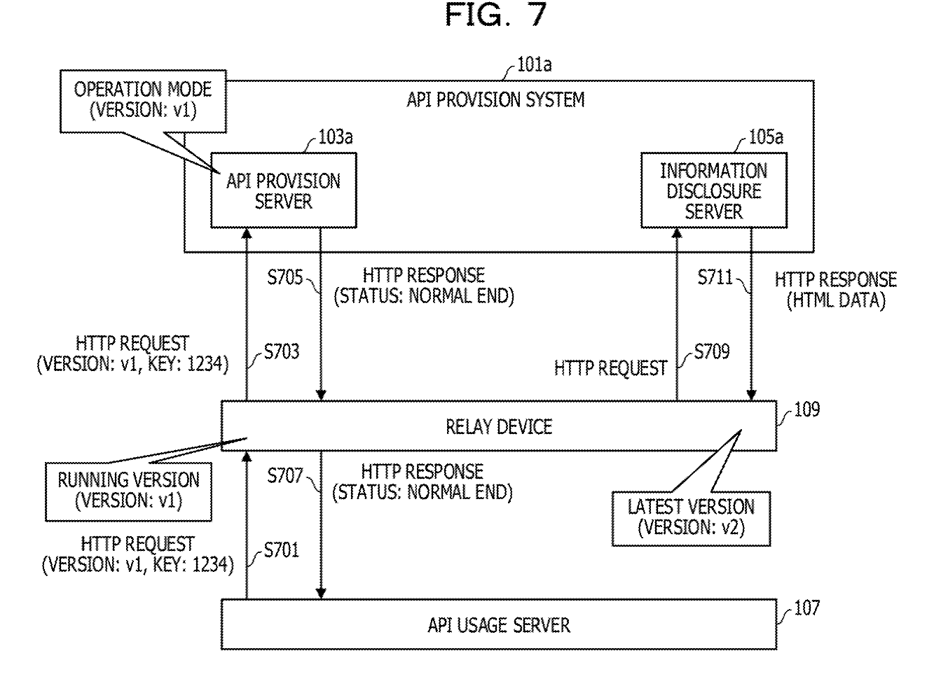

FIG. 7 illustrates an overview of version inspection in the first embodiment. The operation of the API usage server 107 is similar to that in the case in FIG. 3.

The HTTP request having been explained in the explanation about S301 illustrated in FIG. 3 is transmitted to the relay device 109 via the Internet (S701, S703). The HTTP response having been explained in the explanation about S303 illustrated in FIG. 3 is received from the relay device 109 via the Internet (S705, S707). In this example, the relay device 109 extracts a version of the first WebAPI from the HTTP request to be relayed, and stores therein the version as a running version. The relay device 109 accesses the information disclosure server 105a (S709), acquires HTML data of the Web page (S711), and extracts the latest version from the data. The relay device 109 compares the running version with the latest version, and inspects whether provision of the WebAPI of the new version has been started.

In the present embodiment, the relay device 109 also inspects whether the WebAPI of the new version has compatibility with the WebAPI of the previous version.

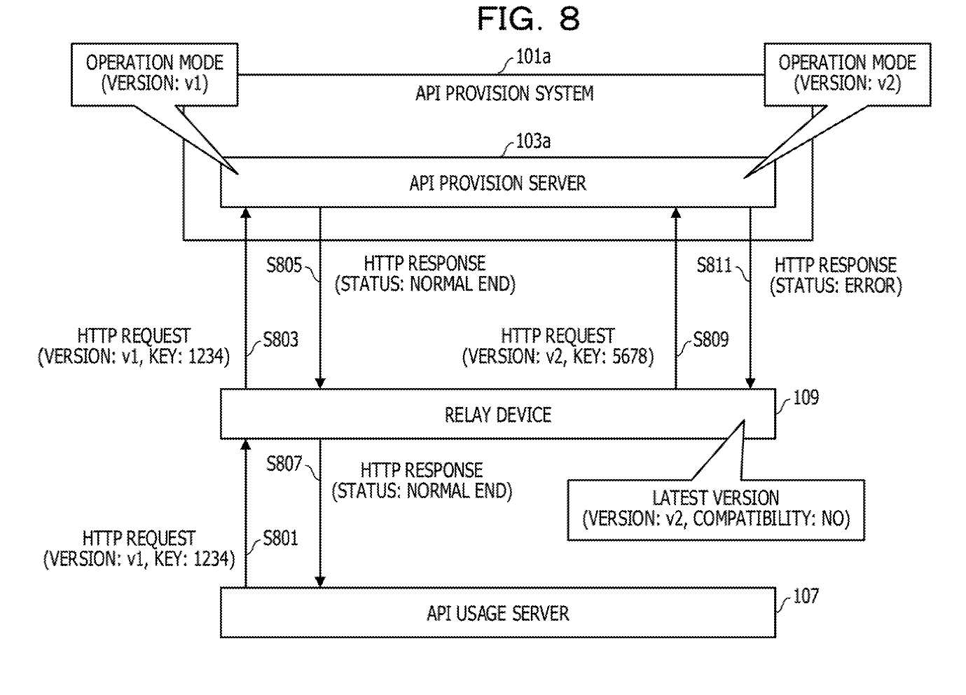

FIG. 8 illustrates an overview of compatibility inspection in the first embodiment. The operation of the API usage server 107 is similar to that in the case in FIG. 3.

The HTTP request having been explained in the explanation about S301 in FIG. 3 is transmitted to the relay device 109 via the Internet (S801, S803). The relay device 109 extracts a content of the request from the HTTP request to be relayed, and holds the content.

The HTTP response having been explained in the explanation about S303 in FIG. 3 is received from the relay device 109 via the Internet (S805, S807). The relay device 109 extracts a content of the response from the HTTP response to be relayed, and holds the content.

The relay device 109 modifies the previous version stored in the HTTP request being held (hereinafter, referred to as an operation request) to the latest version, and further modifies the operational key to the trial key to generate a trial HTTP request (hereinafter, referred to as trial request). The relay device 109 transmits this trial request via the Internet (S809).

The API provision server 103a having received the HTTP request performs processing of the first WebAPI of the version: v2 in the trial mode, and transmits an HTTP response in which return data and a status obtained by the processing are stored, to the API usage server 107 that is a sender of the HTTP request (S811).

The status being an error indicates that the processing of the first WebAPI of the version: v2 has been failed. Accordingly, the relay device 109 determines that the first WebAPI of the latest version is incompatible with the first WebAPI of the previous version.

Even when the status is normal end, if the content of the operation response is different from a content of the trial response, the relay device 109 determines that there is incompatibility. Note that, if the difference falls with a prescribed type, the relay device 109 may determine that there is compatibility in some cases. The exceptional determination will be explained later.

The relay device 109 outputs a screen notifying that the incompatible latest version of the first WebAPI is detected to a display device of the relay device 109.

In this manner, it is possible to provide a trigger to cope with the latest version of the WebAPI to the administrator of the system that utilizes the WebAPI. This is an end of the explanation of the overview in the present embodiment.

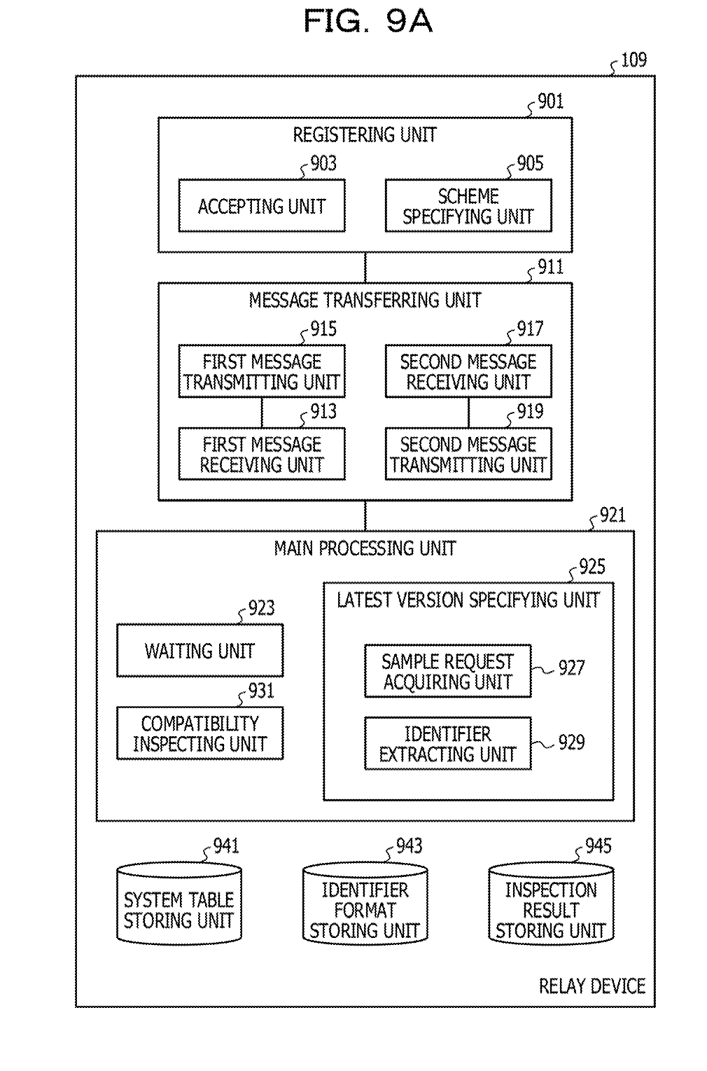

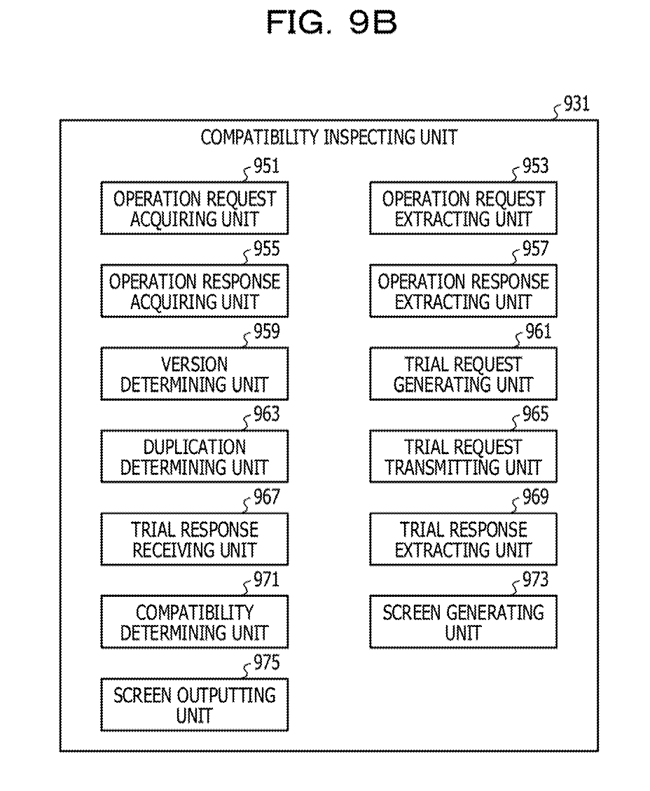

Hereinafter, an operation of the relay device 109 will be explained. FIG. 9A illustrates an example of a module configuration of the relay device 109. The relay device 109 includes a registering unit 901, a message transferring unit 911, and a main processing unit 921.

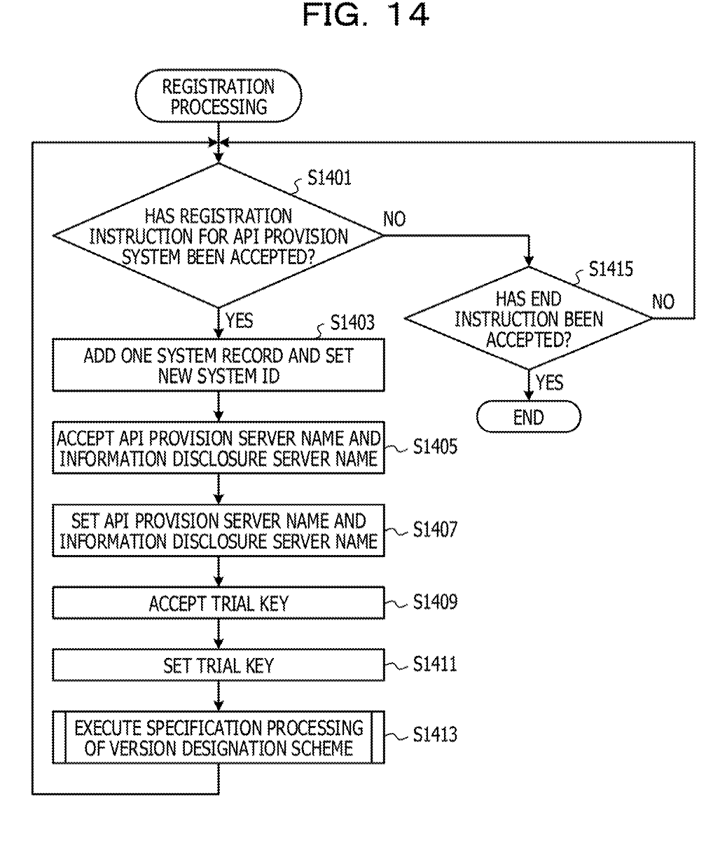

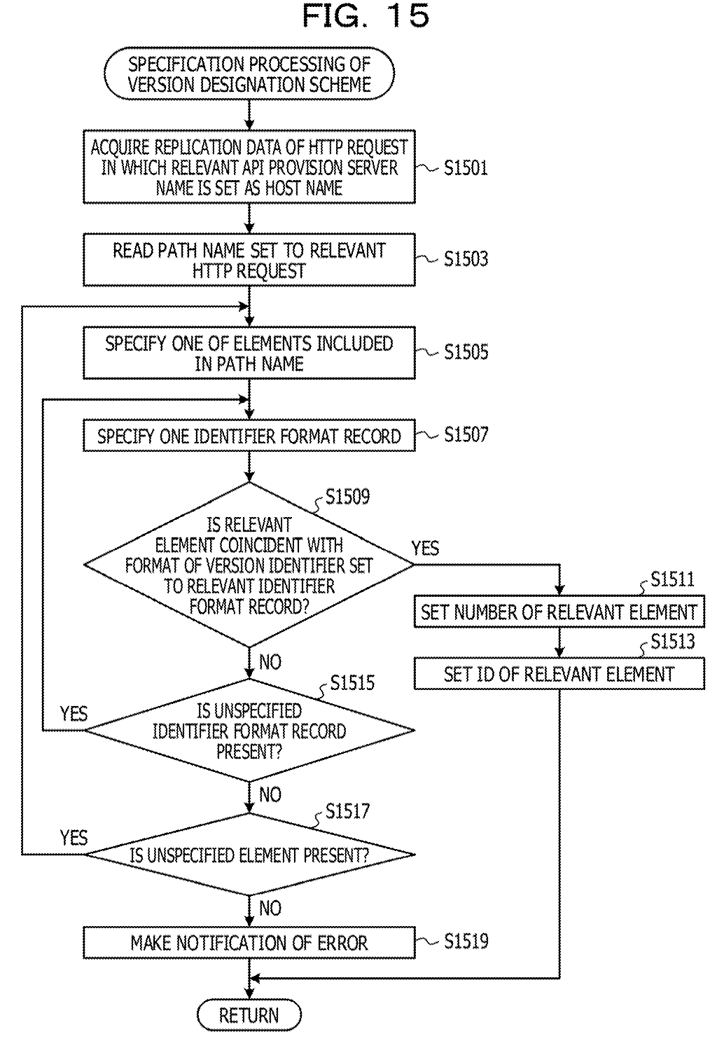

The registering unit 901 registers prescribed data about an API provision system 101 utilized by the API usage server 107. The registering unit 901 includes an accepting unit 903 and a scheme specifying unit 905. The accepting unit 903 accepts various kinds of data by an operation of a user. The scheme specifying unit 905 executes specification processing of a version designation scheme. The specification processing of the version designation scheme will be explained later using FIG. 15.

The message transferring unit 911 transfers a message in accordance with the related art. The message transferring unit 911 includes a first message receiving unit 913, a first message transmitting unit 915, a second message receiving unit 917, and a second message transmitting unit 919. The first message receiving unit 913 receives a message from the LAN. The first message transmitting unit 915 transmits the message received from the LAN to the Internet. The second message receiving unit 917 receives a message from the Internet. The second message transmitting unit 919 transmits the message received from the Internet to the LAN.

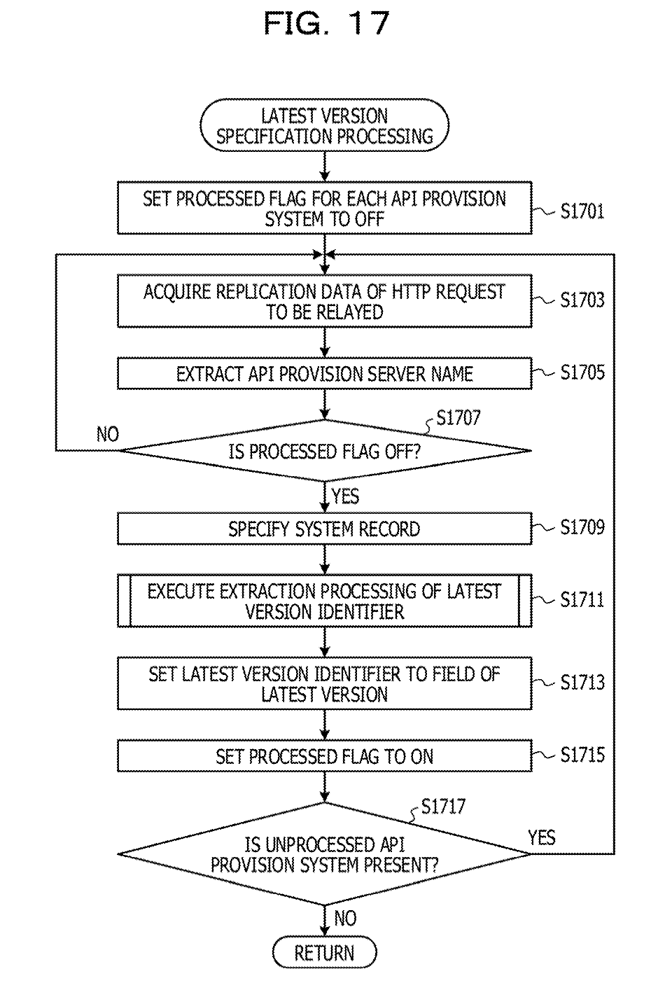

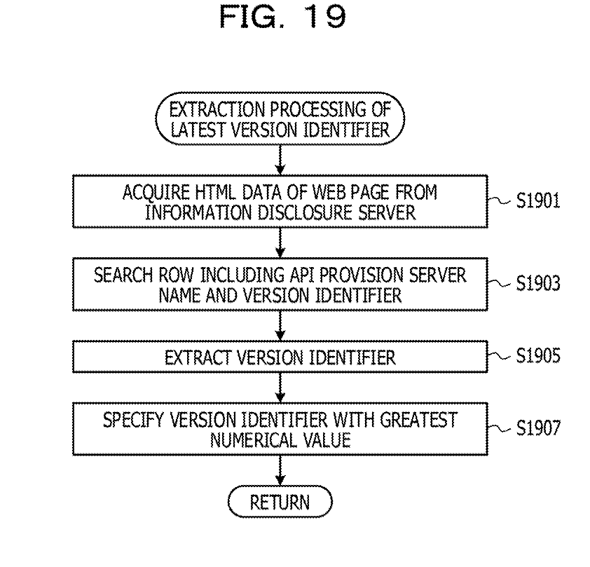

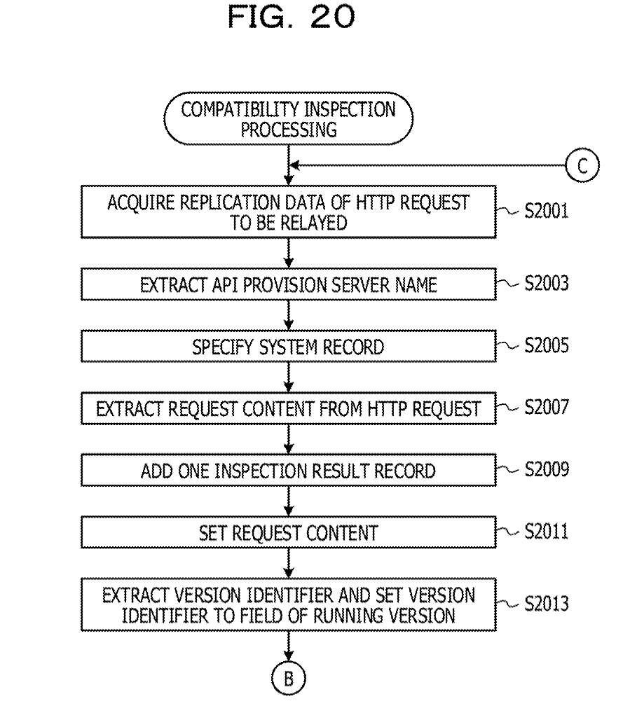

The main processing unit 921 executes main processing. The main processing unit 921 includes a waiting unit 923, a latest version specifying unit 925, and a compatibility inspecting unit 931. The waiting unit 923 performs processing to wait until prescribed timing. The latest version specifying unit 925 executes latest version specification processing. The latest version specification processing will be explained later using FIG. 17. The latest version specifying unit 925 includes a sample request acquiring unit 927 and an identifier extracting unit 929. The sample request acquiring unit 927 acquires replication data of an HTTP request serving as a sample. The identifier extracting unit 929 executes extraction processing of the latest version identifier. The extraction processing of the latest version identifier will be explained later using FIG. 19. The compatibility inspecting unit 931 executes compatibility inspection processing. The compatibility inspection processing will be explained using FIGS. 20, 21, 22 and 26.

FIG. 9B illustrates an example of a module configuration of the compatibility inspecting unit 931. The compatibility inspecting unit 931 includes an operation request acquiring unit 951, an operation request extracting unit 953, an operation response acquiring unit 955, an operation response extracting unit 957, a version determining unit 959, a trial request generating unit 961, a duplication determining unit 963, a trial request transmitting unit 965, a trial response receiving unit 967, a trial response extracting unit 969, a compatibility determining unit 971, a screen generating unit 973, and a screen outputting unit 975.

The operation request acquiring unit 951 acquires replication data of an HTTP request to be relayed. The operation request extracting unit 953 extracts various kinds of data from an operation request. The operation response acquiring unit 955 acquires an HTTP response to the operation request (referred to as operation response). The operation response extracting unit 957 extracts various kinds of data from the operation response. The version determining unit 959 determines whether a version of a WebAPI that is utilized in the operation request matches the latest version. The version of the WebAPI that is utilized in the operation request is a running version.

The trial request generating unit 961 generates a request (trial request) for utilizing the WebAPI of the latest version in the trial mode, based on the operation request. The duplication determining unit 963 determines whether the generated trial request is a duplication of the already transmitted trial request. The trial request transmitting unit 965 transmits the trial request to the Internet. The trial response receiving unit 967 receives an HTTP response (trial response) corresponding to the trial request from the Internet. The trial response extracting unit 969 extracts various kinds of data from the trial response. The compatibility determining unit 971 determines whether there is compatibility between the WebAPI of the latest version and the WebAPI of the running version. The screen generating unit 973 generates a notification screen. The screen outputting unit 975 outputs the notification screen.

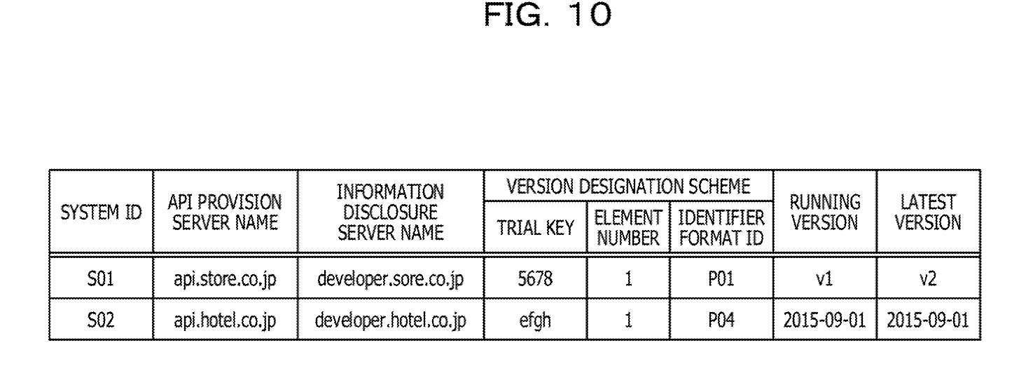

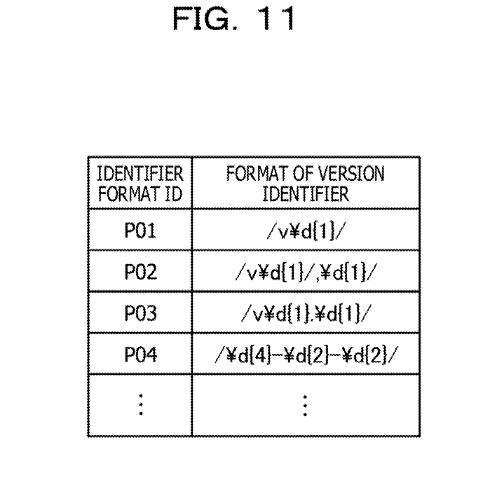

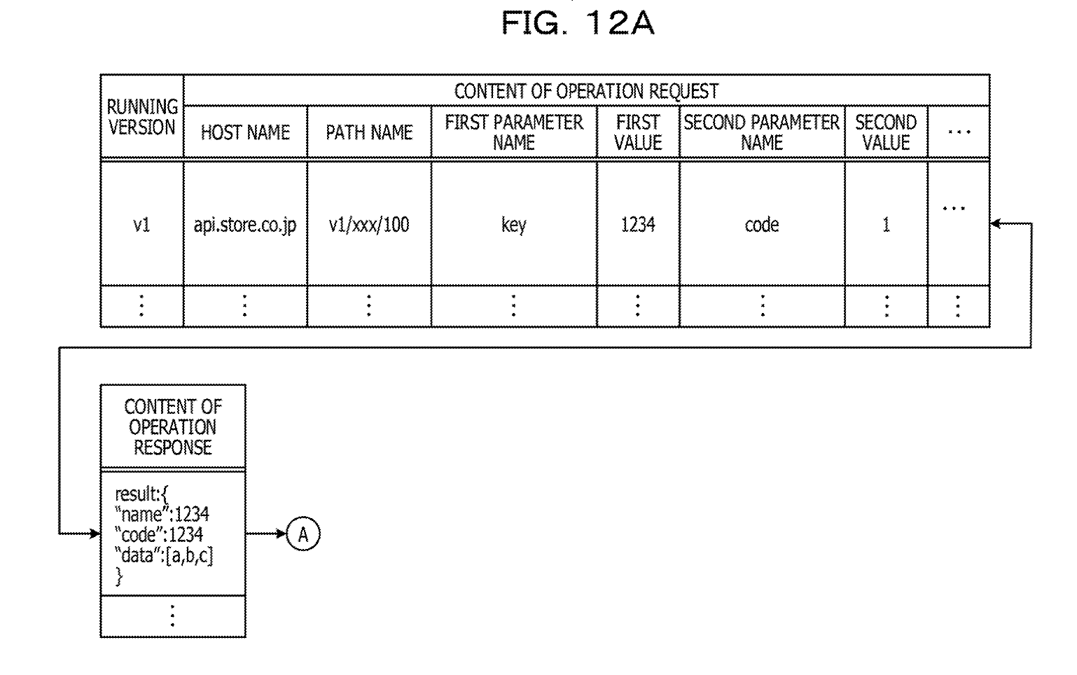

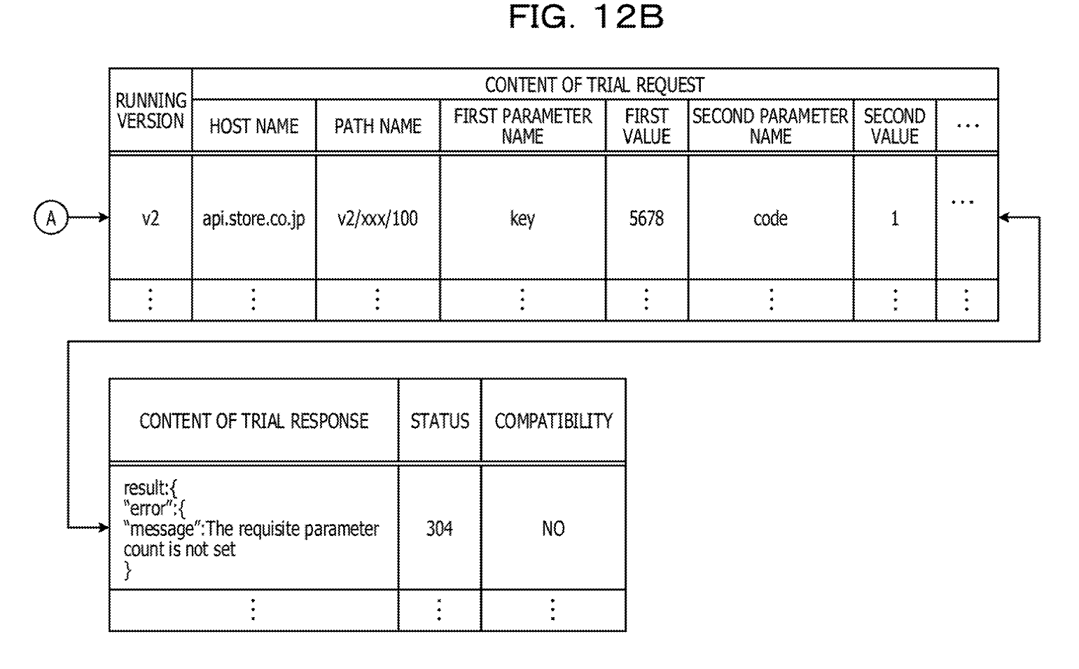

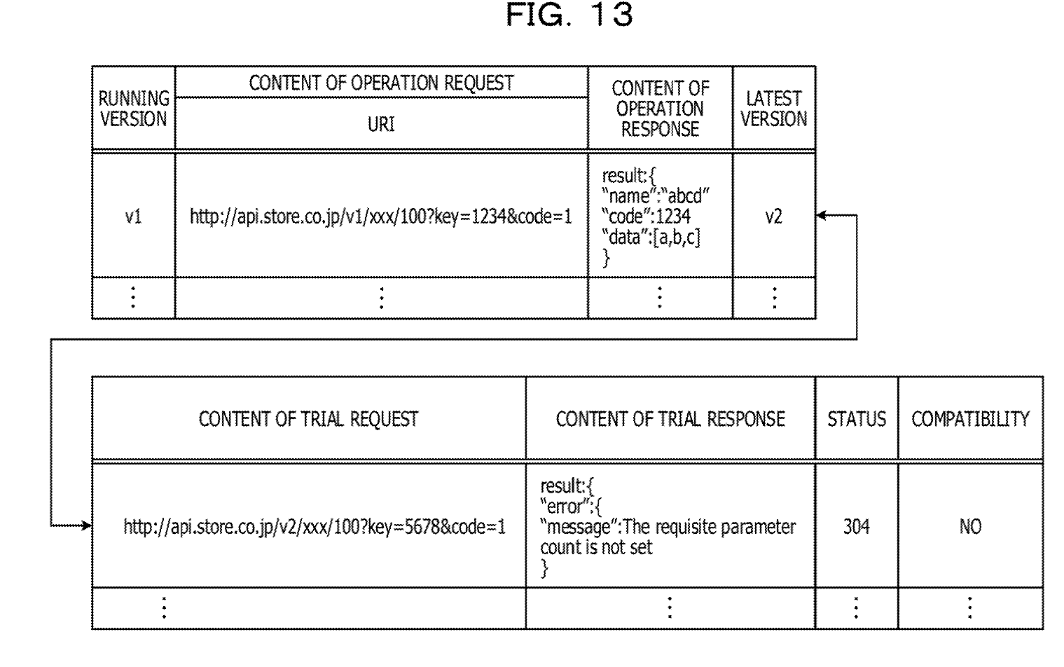

The description returns to the explanation for FIG. 9A. The relay device 109 includes a system table storing unit 941, an identifier format storing unit 943, and an inspection result storing unit 945. The system table storing unit 941 stores therein a system table. The system table will be explained later using FIG. 10. The identifier format storing unit 943 stores therein an identifier format table in advance. The identifier format table will be explained later using FIG. 11. The inspection result storing unit 945 stores therein an inspection result table. The inspection result table will be explained later using FIGS. 12A, 12B, and 13.

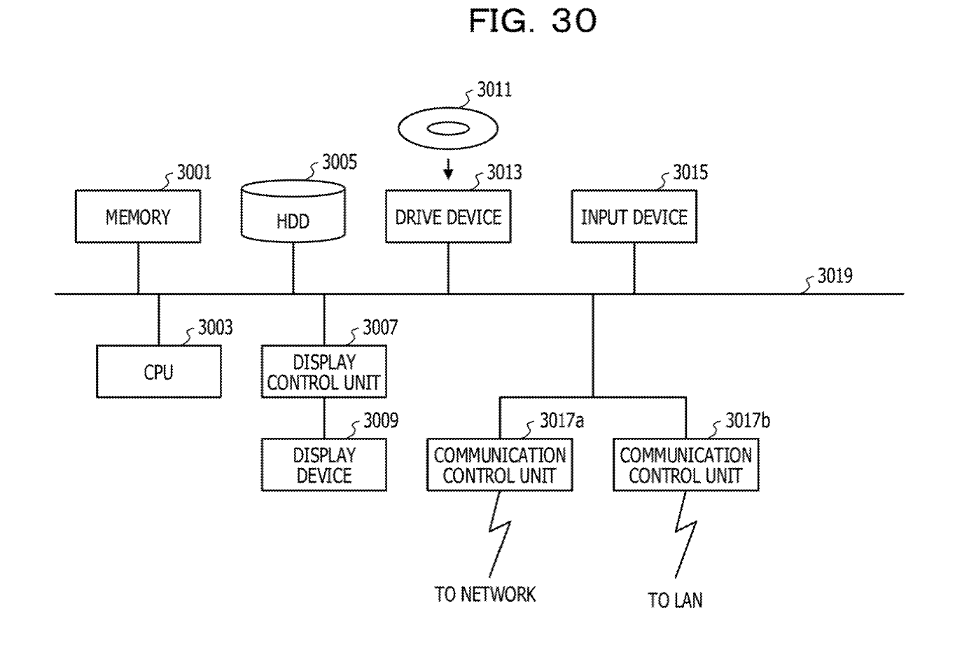

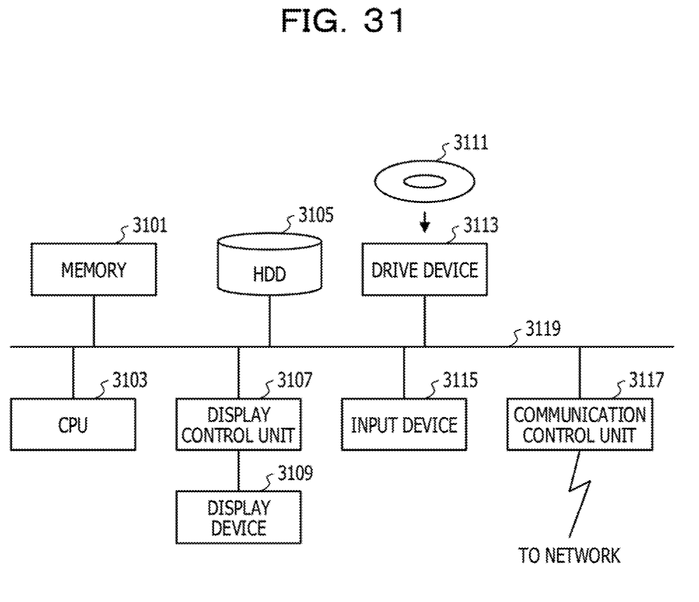

The registering unit 901, the accepting unit 903, the scheme specifying unit 905, the message transferring unit 911, the first message receiving unit 913, the first message transmitting unit 915, the second message receiving unit 917, the second message transmitting unit 919, the main processing unit 921, the waiting unit 923, the latest version specifying unit 925, the sample request acquiring unit 927, the identifier extracting unit 929, and the compatibility inspecting unit 931 described above are implemented using hardware resources (for example, FIG. 30 or 31), and programs that cause central processing units (CPUs) 3003 and 3103 to execute processing described below.

The operation request acquiring unit 951, the operation request extracting unit 953, the operation response acquiring unit 955, the operation response extracting unit 957, the version determining unit 959, the trial request generating unit 961, the duplication determining unit 963, the trial request transmitting unit 965, the trial response receiving unit 967, the trial response extracting unit 969, the compatibility determining unit 971, the screen generating unit 973, and the screen outputting unit 975 described above are implemented by the hardware resources (for example, FIG. 30 or 31), and programs that cause the CPUs 3003 and 3103 to execute the processing described below.

The system table storing unit 941, the identifier format storing unit 943, and the inspection result storing unit 945 described above are implemented using the hardware resources (for example, FIG. 30 or 31).

FIG. 10 illustrates an example of a system table. The system table in this example includes a record (hereinafter, referred to as system record) corresponding to the API provision system 101. The system record includes a field in which a system ID is set, a field in which an API provision server name is set, a field in which an information disclosure server name is set, a field in which a trial key is set, a field of a version designation scheme, a field in which a running version is set, and a field in which the latest version is set.

The system ID identifies the API provision system 101. The API provision server name is a name of an API provision server 103 included in the API provision system 101. The information disclosure server name is a name of an information disclosure server 105 included in the API provision system 101. The trial key is a key to be used when a WebAPI provided by the API provision system 101 is utilized in the trial mode, in the relay device 109.

The version designation scheme is a scheme of designating a version in a path name included in the URI. The field of the version designation scheme includes a field in which an element number is set and a field in which an identifier format ID is set. The element number specifies the order of an element corresponding to the version identifier in the path name included in the URI. The identifier format ID specifies a format of the version identifier. The format of the version identifier will be explained later using FIG. 11.

The running version is a version of a WebAPI utilized by the API usage program 201 in the operation mode. The latest version is the latest version in the WebAPI provided by the API provision system 101.

FIG. 11 illustrates an example of an identifier format table. The identifier format table in this example includes a record (hereinafter, referred to as identifier format record) corresponding to the format of the version identifier. The identifier format record includes a field in which an identifier format ID is set, and a field in which a format of the version identifier is set.

The identifier format ID identifies a format of the version identifier. The format of the version identifier is a regular expression of the version identifier.

FIGS. 12A and 12B illustrate a first example of the inspection result table. An inspection result in the first example includes a record (hereinafter, referred to as inspection result record) of an inspection result about one request. The inspection result record includes a field in which a running version is set, a field of a content of an operation request, a content of an operation response is set, a field in which the latest version is set, a field of a content of a trial request, a field in which a content of a trial response is set, a field in which a status is set, and a field in which compatibility is set.

The content of an operation request specifies a URI serving as a source of an HTTP request to be transmitted when the WebAPI of the previous version is utilized in the operation mode. The field of the content of the operation request in this example includes a field in which a host name is set, a field in which a path name is set, a field in which a first parameter name is set, a field in which a first value is set, a field in which a second parameter name is set, and a field in which a second value is set. The first value is a value of the first parameter. The second value is a value of the second parameter. A third parameter and subsequent parameters are similar to the cases of the first parameter and the second parameter.

The content of the operation response corresponds to return data of the WebAPI of the previous version included in an HTTP response corresponding to the operation request.

The content of a trial request specifies a URI serving as a source of an HTTP request to be transmitted when the WebAPI of the latest version is utilized in the trial mode. The fields of the content of the trial request in this example are similar to the fields of the content of the operation request.

The content of the trial response corresponds to return data of the WebAPI of the latest version included in an HTTP response corresponding to the trial request.

The status is a status in the trial response. When the WebAPI operates normally, the status is a code of a normal end.

The compatibility is compatibility between the WebAPI of the latest version and the WebAPI of the previous version being utilized in the operation mode.

FIG. 13 illustrates a second example of the inspection result table. The inspection result in the second example includes, similar to the case of the first example, an inspection result record. The inspection result record includes, similar to the case of the first example, a field in which a running version is set, a field of a content of an operation request, a content in which an operation response is set, a field in which the latest version is set, a field of a content of a trial request, a field in which a content of a trial response is set, a field in which a status is set, and a field in which compatibility is set.

Note that, the content of an operation request is set in a format of a URI. The content of a trial request is set in a format of a URI. The others are similar to those in the case of the first example. Both of the first example and the second example described above may be used.

Subsequently, registration processing in the registering unit 901 will be explained. It is assumed that an administrator of the relay device 109 and of the API usage server 107 registers in advance prescribed data about the API provision system 101 utilized by the API usage server 107 with the relay device 109.

FIG. 14 illustrates a registration processing flow. The accepting unit 903 branches the processing depending on whether the accepting unit 903 has accepted an instruction of the registration for the API provision system 101 due to an operation by the administrator (S1401).

If the accepting unit 903 has accepted the instruction of the registration for the API provision system 101, the accepting unit 903 adds one system record into a system table, and sets a new system ID to the system record (S1403).

The accepting unit 903 accepts an API provision server name and an information disclosure server name that are inputted due to an operation by the administrator (S1405). The accepting unit 903 sets the API provision server name and the information disclosure server name to the new system record (S1407).

The accepting unit 903 accepts a trial key that is inputted due to an operation by the administrator (S1409). It is assumed that the administrator acquires in advance a trial key to be used by the relay device 109 for inspection from the API provision system 101. The accepting unit 903 sets the trial key to the new system record (S1411).

The scheme specifying unit 905 executes specification processing of the version designation scheme (S1413). The scheme specifying unit 905 specifies a scheme of designating a version, in the path name included in the URI in the specification processing of the version designation scheme. The scheme of designating a version in the path name is uniquely decided by each WebAPI.

FIG. 15 illustrates a specification processing flow of the version designation scheme. The scheme specifying unit 905 acquires replication data of an HTTP request in which the API provision server name accepted at S1405 is set as a host name of the access destination (S1501). The scheme specifying unit 905 reads a path name being set to the replicated HTTP request (S1503).

The scheme specifying unit 905 specifies one of the elements included in the path name (S1505). The elements in the path name are portions separated with the forward slash marks.

The scheme specifying unit 905 specifies one identifier format record in the identifier format table (S1507). The scheme specifying unit 905 determines whether the element specified at S1505 is coincident with a format of the version identifier set to the identifier format record (S1509). If the element is coincident with the format of the version identifier, the scheme specifying unit 905 sets a number of the element to the system record added at S1403 of FIG. 14 (S1511). The scheme specifying unit 905 sets an ID of the identifier format to the system record (S1513). The specification processing of the version designation scheme is ended, and the processing is recovered to the registration processing that is a calling source.

On the other hand, if the scheme specifying unit 905 determines that the element specified at S1505 is not coincident with a format of the version identifier being set to the identifier format record, the scheme specifying unit 905 determines whether an unspecified identifier format record is present at S1507 (S1515). If the scheme specifying unit 905 determines that an unspecified identifier format record is present, the processing is returned to the process indicated at S1507, and repeats the processes described above.

On the other hand, if the scheme specifying unit 905 determines that no unspecified identifier format record is present, the scheme specifying unit 905 determines whether an unspecified element is present at S1505 (S1517). If the scheme specifying unit 905 determines that an unspecified element is present, the processing is returned to the process indicated at S1505, and repeats the processes described above.

On the other hand, if the scheme specifying unit 905 determines that no unspecified element is present, the scheme specifying unit 905 makes notification of an error (S1519). The API provision system 101 determined as an error is, for example, excluded from a target of evaluation. After the specification processing of the version designation scheme is ended, the processing is recovered to the registration processing that is a calling source.

The description returns to the explanation for FIG. 14. After the specification processing of the version designation scheme at S1413 is ended, the processing is returned to the process indicated at S1401, and repeats the processes described above.

If the accepting unit 903 has not accepted an instruction of the registration for the API provision system 101 at S1401, the accepting unit 903 determines whether an end instruction due to an operation by the administrator has accepted (S1415). If the accepting unit 903 has not accepted an end instruction due to an operation by the administrator, the processing is returned to the process indicated at S1401, and repeats the processes described above. On the other hand, if the accepting unit 903 has accepted an end instruction due to an operation by the administrator, the registration processing is ended.

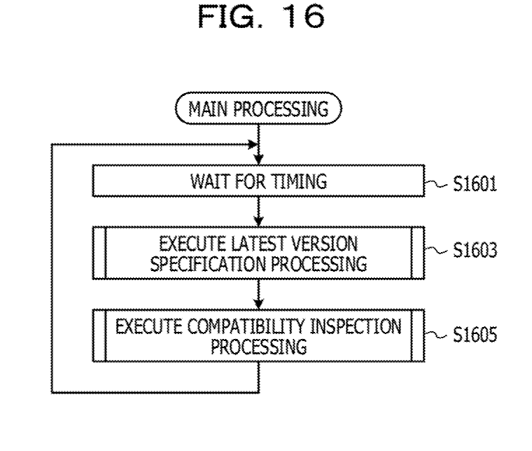

Subsequently, main processing by the main processing unit 921 will be explained. FIG. 16 illustrates a main processing flow. In the main processing, inspection about each API provision system 101 is performed at prescribed timing (for example, cyclical timing as a fixed time every day). Accordingly, the waiting unit 923 waits for the prescribed timing (S1601).

The latest version specifying unit 925 executes the latest version specification processing (S1603). The latest version specifying unit 925 specifies the latest version in each API provision system 101 in the latest version specification processing.

FIG. 17 illustrates a latest version specification processing flow. The latest version specifying unit 925 sets a processed flag corresponding to each API provision system 101 to OFF (S1701). The processed flag is an internal parameter for distinguishing whether the state is a state where the latest version has been already specified.

The sample request acquiring unit 927 acquires replication data of an HTTP request to be relayed, in other words, for example, the HTTP request received by the first message receiving unit 913 (S1703).

The latest version specifying unit 925 extracts an API provision server name from the replicated HTTP request (S1705). The latest version specifying unit 925 determines whether a processed flag corresponding to the extracted API provision server name is OFF (S1707).

If the latest version specifying unit 925 determines that a processed flag corresponding to the API provision server name is not OFF, in other words, for example, when the processed flag is ON, the processing is returned to the process indicated at S1703, and repeats the processes described above.

If the latest version specifying unit 925 determines that a processed flag corresponding to the API provision server name is OFF, the latest version specifying unit 925 specifies a system record in which the API provision server name is set in the system table (S1709).

The identifier extracting unit 929 executes extraction processing of the latest version identifier (S1711). The identifier extracting unit 929 extracts an identifier of the latest version of the WebAPI from a Web page of the information disclosure server 105, in the extraction processing of the latest version identifier.

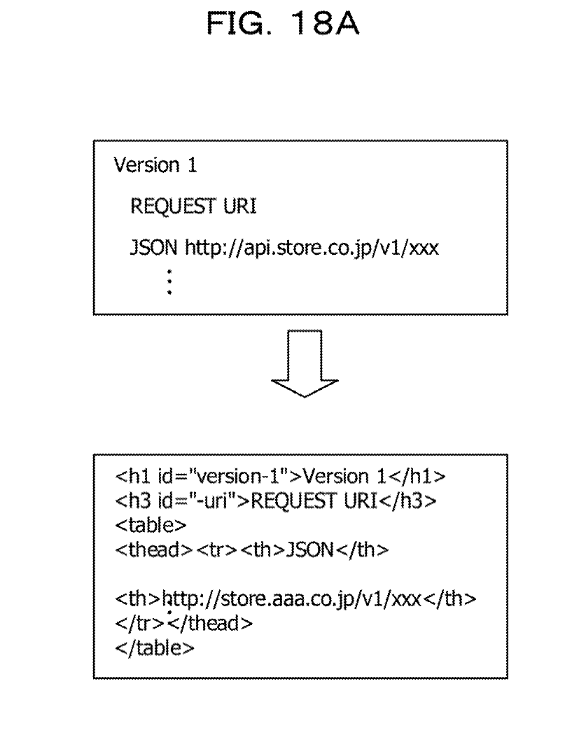

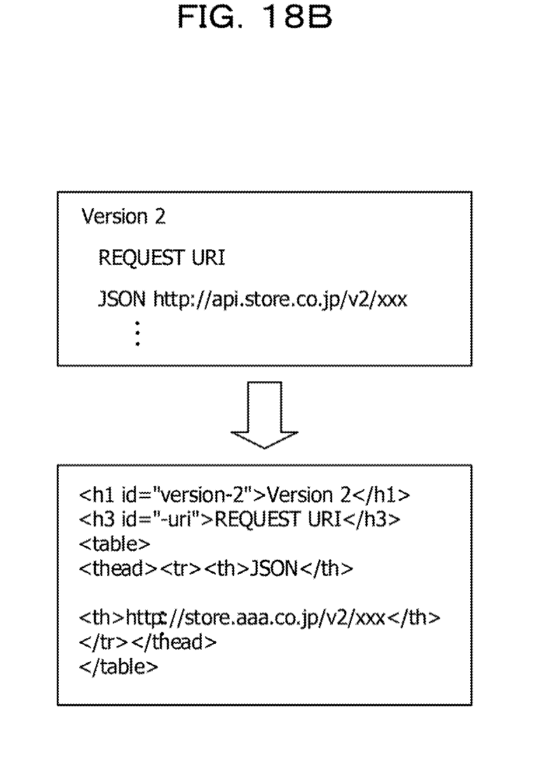

Before the extraction processing of the latest version identifier is explained, a Web page of the information disclosure server 105 will be explained. FIGS. 18A and 18B illustrate examples of a Web page of the information disclosure server 105a. FIG. 18A illustrates a part of the Web page on which an article about a notification of the version: v1 appears. In this example, a URI (excluding parameters) for utilizing the first WebAPI of the version: v1 is illustrated.

In the lower row, a description portion about the URI in hypertext markup language (HTML) data of the Web page is illustrated. In this manner, code strings of the URL are described.

FIG. 18B illustrates a part of the Web page on which an article about a notification of the version: v2 appears. In this example, a URI (excluding parameters) for utilizing the first WebAPI of the version: v2 is illustrated.

In the lower row, a description portion about the URI in HTML data of the Web page is illustrated. In this manner, code strings of the URL are described.

FIG. 19 illustrates an extraction processing flow of the latest version identifier. The identifier extracting unit 929 acquires HTML data of the Web page from the information disclosure server 105, based on an information disclosure server name that is set to the system record specified at S1709 (S1901). When the information disclosure server 105 provides a plurality of Web pages, the identifier extracting unit 929 acquires HTML data of each Web page. For example, a tool of analyzing the configuration of the Web page may be used.

The identifier extracting unit 929 refers to an identifier format table, and specifies a format of the version identifier corresponding to an identifier format ID that is set to the system record specified at S1709. The identifier extracting unit 929 searches a row including the API provision server name extracted at S1705 of FIG. 17 and the version identifier in the format, in the acquired HTML data (S1903).

The identifier extracting unit 929 extracts a version identifier from the row (S1905). When a plurality of rows is present, the identifier extracting unit 929 extracts a version identifier from each row. When the identifier extracting unit 929 extracts a plurality of version identifiers, the identifier extracting unit 929 specifies a version identifier with the greatest numerical value (S1907). In the case of a version identifier of a date format, the identifier extracting unit 929 specifies a version identifier corresponding to the newest date. After the extraction processing of the latest version identifier is ended, the processing is recovered to the latest version specification processing that is a calling source.

The description returns to the explanation for FIG. 17. The identifier extracting unit 929 sets the latest version identifier extracted in the extraction processing of the latest version identifier to a field of the latest version in the system record specified at S1709 (S1713).

The latest version specifying unit 925 sets a processed flag corresponding to the API provision server name extracted at S1705 of FIG. 17 to ON (S1715). The latest version specifying unit 925 determines whether an unprocessed API provision system 101 is present (S1717). Specifically, for example, the latest version specifying unit 925 determines whether a flag set to OFF is present in processed flags corresponding to the respective API provision systems 101. If a processed flag set to OFF is present, the latest version specifying unit 925 determines that an unprocessed API provision system 101 is present. On the other hand, if no processed flag set to OFF is present, the latest version specifying unit 925 determines that no unprocessed API provision system 101 is present.

If the latest version specifying unit 925 determines that an unprocessed API provision system 101 is present, the processing is returned to the process indicated at S1703, and repeats the processes described above. On the other hand, if the latest version specifying unit 925 determines that no unprocessed API provision system 101 is present, the latest version specification processing is ended, and the processing is recovered to the main processing that is a calling source.

The description returns to the explanation for FIG. 16. After the latest version specification processing is ended, the compatibility inspecting unit 931 executes compatibility inspection processing (S1605). When the version being utilized by the API usage program 201 in the operation mode is not the latest version, in the compatibility inspection processing, the compatibility inspecting unit 931 inspects compatibility between the WebAPI of the latest version and the WebAPI of the previous version being utilized in the operation mode. Note that, the latest version specification processing and the compatibility inspection processing are not required to be successively performed. The compatibility inspection processing may be started at timing different from that of the latest version specification processing.

FIG. 20 illustrates a compatibility inspection processing flow. The operation request acquiring unit 951 acquires replication data of an HTTP request to be relayed, in other words, for example, the HTTP request received by the first message receiving unit 913 (S2001). The operation request extracting unit 953 extracts an API provision server name from the replicated HTTP request (S2003). The operation request extracting unit 953 specifies a system record in which the extracted API provision server name is set in the system table (S2005).

The operation request extracting unit 953 extracts a content of the request from the acquired HTTP request (S2007). The content of the request corresponds to a group of a host name, a path name, a parameter name, and a value of the parameter, in the URI serving as a foundation.

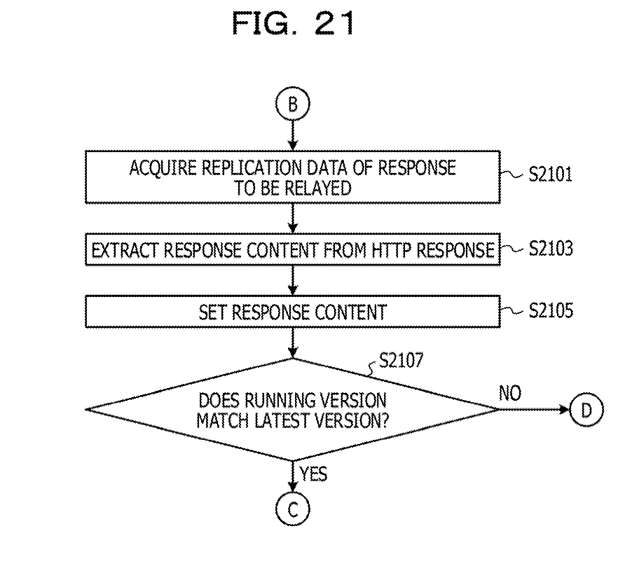

The operation request extracting unit 953 adds one inspection result record to the inspection result table (S2009). The operation request extracting unit 953 sets the content of the request to the added inspection result record (S2011). The operation request extracting unit 953 extracts a version identifier from the path name, and sets the version identifier to the field of the running version in the added inspection result record (S2013). The processing is proceeded to a process at S2101 illustrated in FIG. 21 via a terminal B.

The description moves to the explanation for FIG. 21. The operation response acquiring unit 955 acquires replication data of a response to the HTTP request acquired at S2001 (S2101). The operation response extracting unit 957 extracts a response content from the replicated HTTP response (S2103). The response content is a text stored in a body of the HTTP response. The operation response extracting unit 957 sets the extracted response content to the inspection result record added at S2009 (S2105).

The version determining unit 959 determines whether a running version set to the system record matches the latest version being set to the system record (S2107). If the version determining unit 959 determines that the running version matches the latest version, the processing is returned to a process at S2001 illustrated in FIG. 20 via a terminal C.

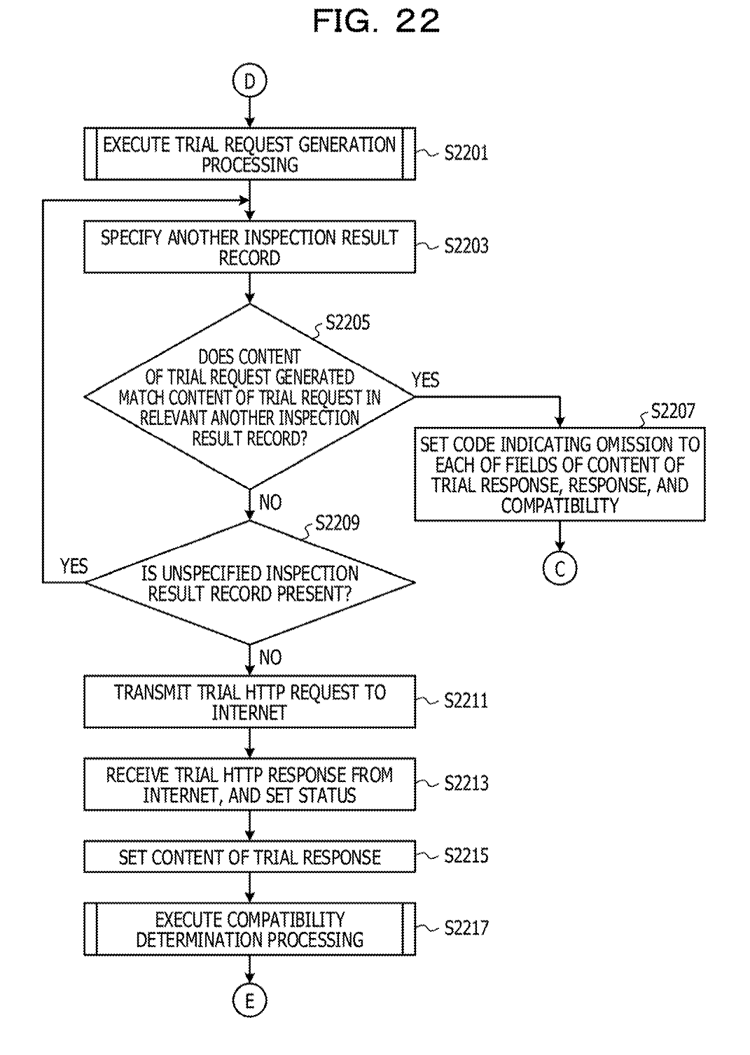

On the other hand, if the version determining unit 959 determines that the running version does not match the latest version, the processing is moved to a process at S2201 illustrated in FIG. 22 via a terminal D.

The description moves to the explanation for FIG. 22. The trial request generating unit 961 executes trial request generation processing (S2201). The trial request generating unit 961 generates a trial request to be called using a trial key of the WebAPI of the latest version based on the operation request, in the trial request generation.

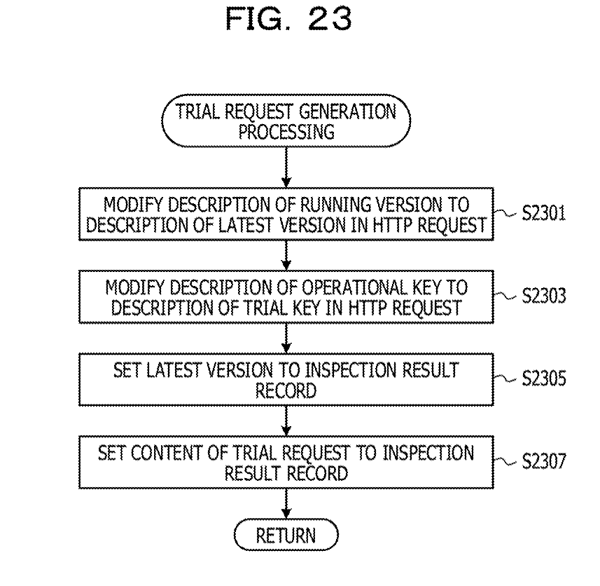

FIG. 23 illustrates a trial request generation processing flow. The trial request generating unit 961 modifies the description of the running version to the description of the latest version in the HTTP request (S2301). The running version and the latest version have been set to the system record.

The trial request generating unit 961 modifies the description of the operational key to the description of the trial key in the HTTP request (S2303).

The trial request generating unit 961 sets the latest version to the inspection result record added at S2009 of FIG. 20 (S2305). The trial request generating unit 961 similarly sets the content of the trial request to the inspection result record (S2307). After the trial request generation processing is ended, the processing is recovered to the compatibility inspection processing that is a calling source.

The description returns to the explanation for FIG. 22. The duplication determining unit 963 specifies another inspection result record, in other words, for example, one inspection result record other than the added inspection result record (S2203). The duplication determining unit 963 determines whether the content of the trial request generated in the trial request generation processing matches the content of the trial request in the another inspection result record (S2205). If the duplication determining unit 963 determines that the contents of the both of the trial requests match each other, the duplication determining unit 963 sets a code indicating omission to each of the fields of the content of the trial response, the response, and the compatibility, in the added inspection result record (S2207). The processing is returned to the process at S2001 illustrated in FIG. 20 via the terminal C.

On the other hand, if the duplication determining unit 963 determines that the contents of the both of the trial requests do not match each other at S2205, the duplication determining unit 963 determines whether an unspecified inspection result record is present at S2203 (S2209). If the duplication determining unit 963 determines that an unspecified inspection result record is present, the processing is returned to the process indicated at S2203, and repeats the processes described above. On the other hand, if the duplication determining unit 963 determines that no unspecified inspection result record is present, the trial request transmitting unit 965 transmits the trial request generated at S2201 to the Internet (S2211).

This manner makes it possible to omit the inspection of the same requests. Note that, the processes at S2203 to S2209 may be omitted, and the inspection of the same request may be repeated.

The trial response receiving unit 967 receives a trial response corresponding to the trial request from the Internet, and sets a status of the trial response to an evaluation result record (S2213). The trial response extracting unit 969 extracts a content of the response extracts from the trial response, and sets the extracted content of the response to the evaluation result record (S2215).

The compatibility determining unit 971 executes compatibility determination processing (S2217). The compatibility determining unit 971 determines whether the WebAPI of the latest version has compatibility with the WebAPI of the running version, in the compatibility determination processing.

FIG. 24 illustrates the compatibility determination processing flow. The compatibility determining unit 971 determines whether the status of the trial response is a normal end (S2401). If the compatibility determining unit 971 determines that the status of the trial response is not a normal end, the compatibility determining unit 971 determines that there is incompatibility (S2403). The compatibility determination processing is ended, and the processing is recovered to the compatibility inspection processing that is a calling source.

On the other hand, if the compatibility determining unit 971 determines that the status of the trial response is an normal end at S2401, the compatibility determining unit 971 determines whether the content of the trial response being set to the evaluation result record matches the content of the operation response (S2405). If the compatibility determining unit 971 determines that the content of a trial response matches the content of the operation response, the compatibility determining unit 971 determines that there is compatibility (S2407). The compatibility determination processing is ended, and the processing is recovered to the compatibility inspection processing that is a calling source.

On the other hand, the compatibility determining unit 971 determines that the content of the trial response does not match the content of the operation response, the compatibility determining unit 971 specifies one difference portion between the content of the trial response and the content of the operation response (S2409).

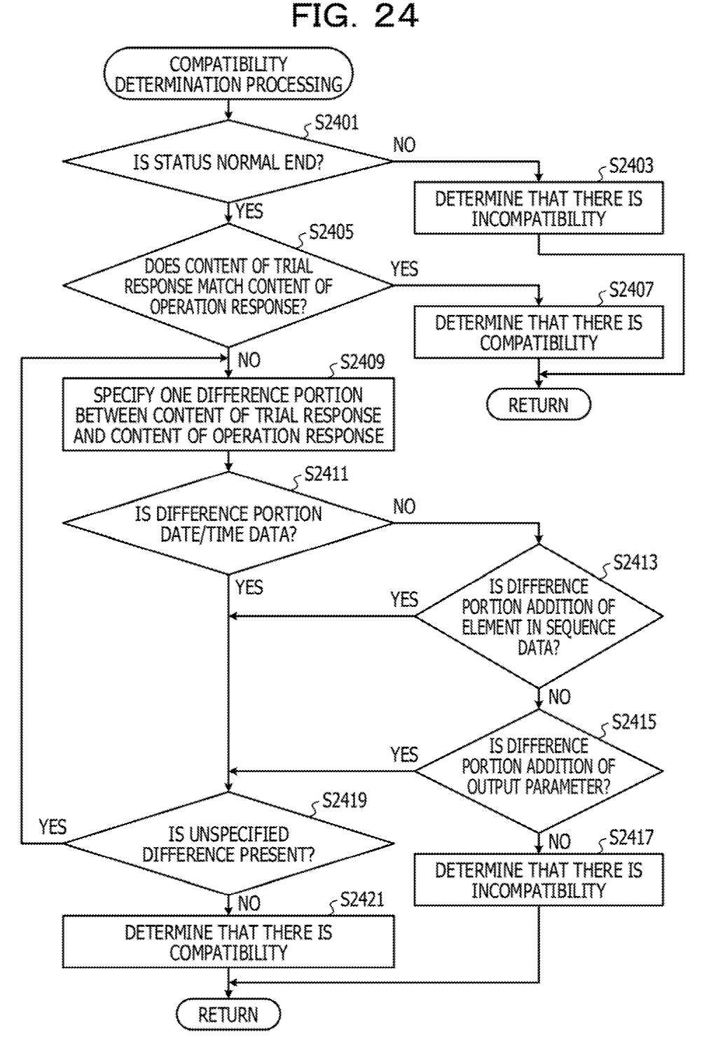

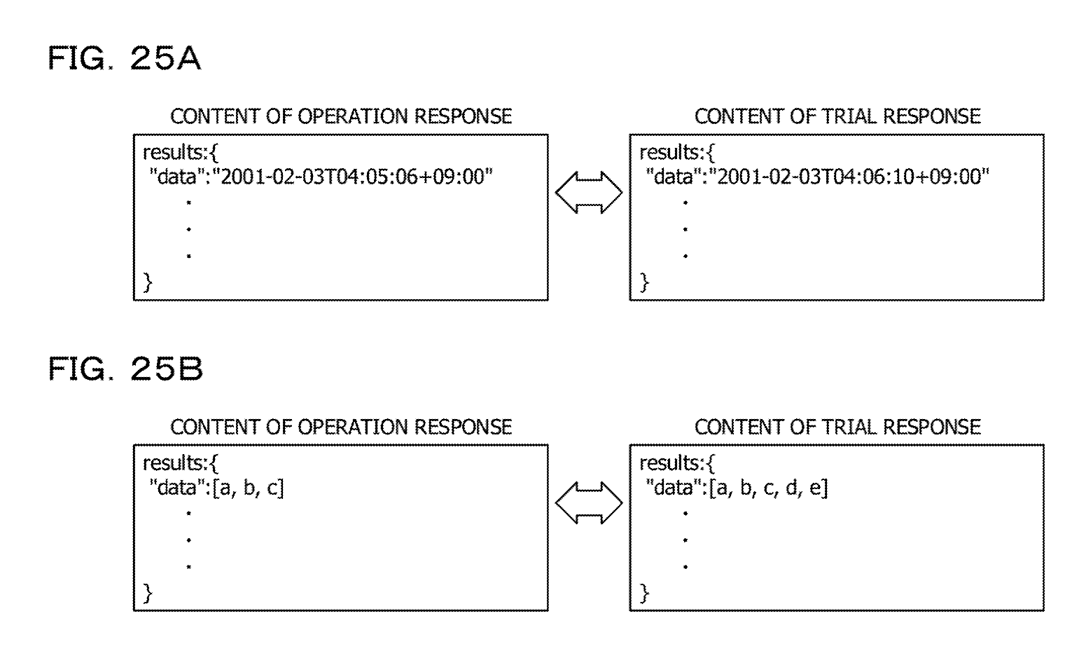

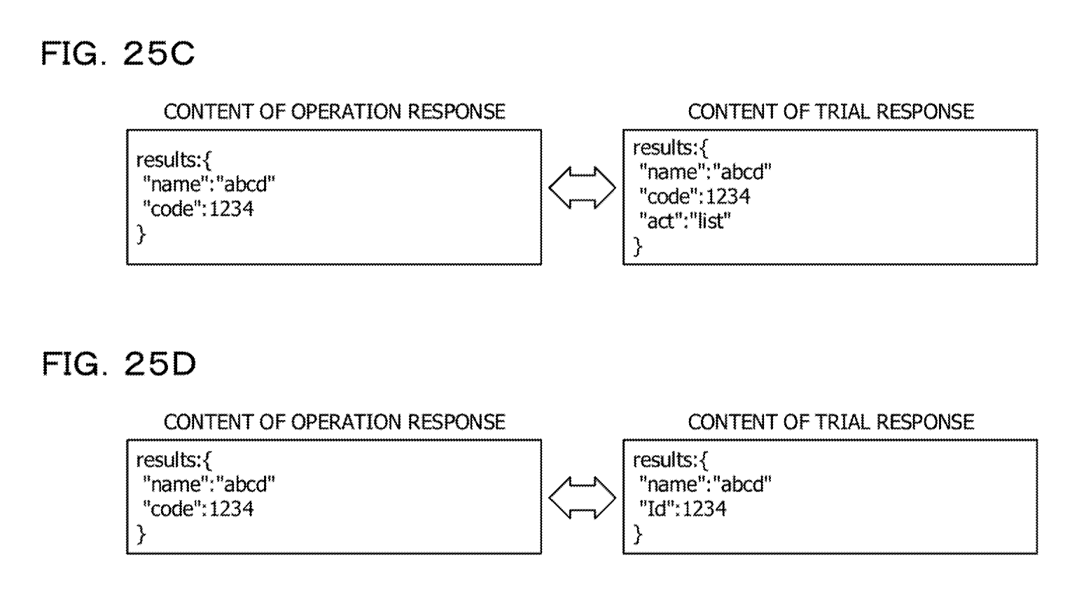

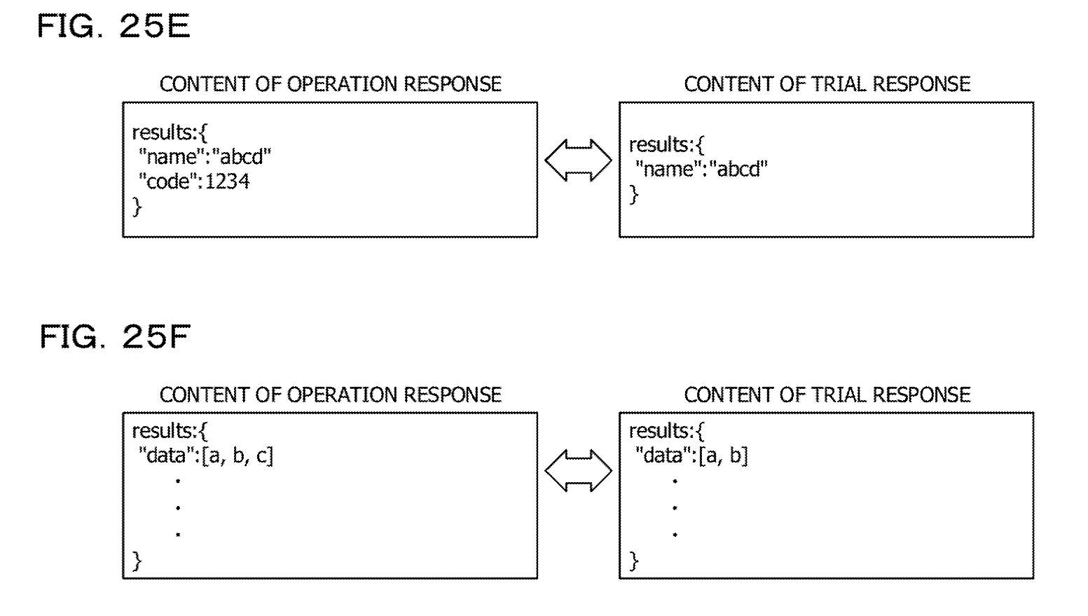

The compatibility determining unit 971 determines whether the specified difference portion is date/time data (S2411). As illustrated in FIG. 25A, if the specified difference portion is date/time data, the compatibility determining unit 971 does not determine that there is incompatibility, but the processing is moved to a process at S2419.

On the other hand, if the specified difference portion is not date/time data, the compatibility determining unit 971 determines whether the specified difference portion is addition of an element in sequence data (S2413). As illustrated in FIG. 25B, if the specified difference portion is addition of an element in the sequence data, the compatibility determining unit 971 does not determine that there is incompatibility, but the processing is moved to the process at S2419.

On the other hand, if the specified difference portion is not addition of an element in the sequence data, the compatibility determining unit 971 determines whether the specified difference portion is addition of an output parameter (S2415). If the specified difference portion is not addition of an output parameter, the compatibility determining unit 971 determines that there is incompatibility (S2417). The compatibility determination processing is ended, and the processing is recovered to the compatibility inspection processing that is a calling source.

On the other hand, as illustrated in FIG. 25C, if the specified difference portion is addition of an output parameter, the compatibility determining unit 971 does not determine that there is incompatibility, but determines whether an unspecified difference is present at S2409 (S2419). If the compatibility determining unit 971 determines that an unspecified difference is present, the processing is returned to the process indicated at S2409, and repeats the processes described above.

On the other hand, the compatibility determining unit 971 determines that no unspecified difference is present, the compatibility determining unit 971 determines that there is compatibility (S2421). The compatibility determination processing is ended, and the processing is recovered to the compatibility inspection processing that is a calling source.

For example, when the specified difference portion is a change in the output parameter as illustrated in FIG. 25D, if the specified difference portion is deletion of the output parameter as illustrated in FIG. 25E or deletion of an element in the sequence data as illustrated in FIG. 25F, the incompatibility is determined.

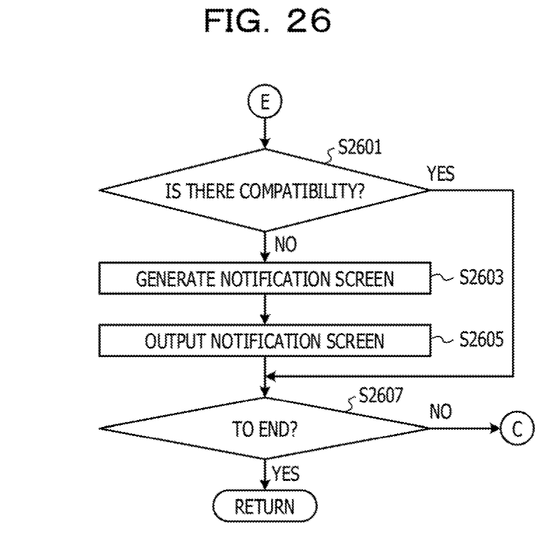

The description returns to the explanation for FIG. 22. When the compatibility determination processing at S2217 is ended, the processing is moved to a process at S2601 illustrated in FIG. 26, via a terminal E.

The description moves to an explanation of FIG. 26. The compatibility inspecting unit 931 branches a process depending on whether there is compatibility (S2601). If the compatibility inspecting unit 931 determines that there is compatibility, the processing is moved to a process at S2607.

On the other hand, if the compatibility inspecting unit 931 determines that there is incompatibility, the screen generating unit 973 generates a notification screen (S2603).

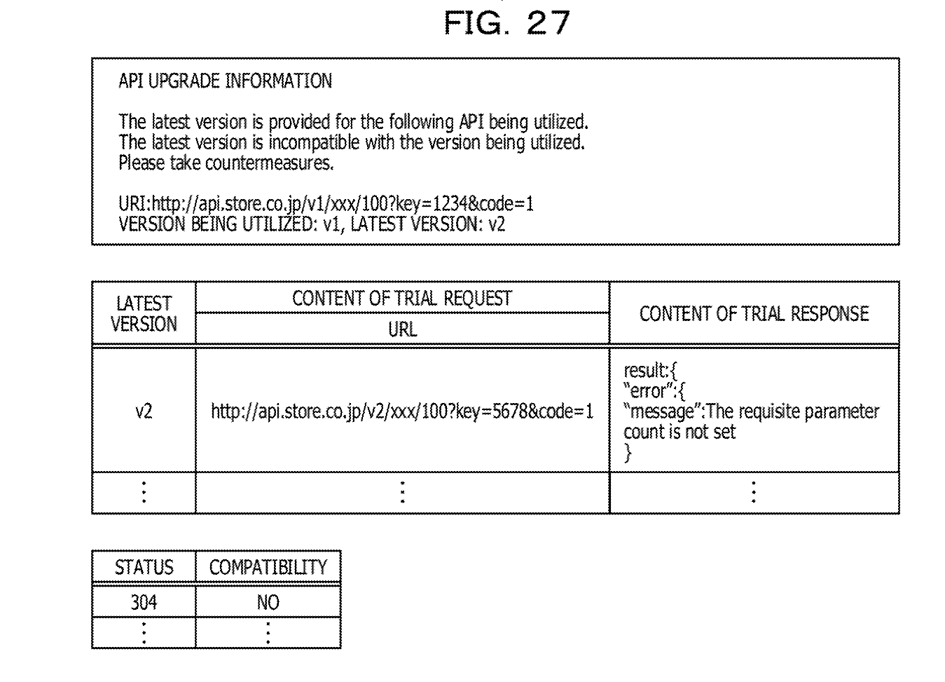

FIG. 27 illustrates an example of the notification screen. A fact that the latest version having incompatibility with the running version is provided is described on the notification screen. Detailed data corresponding to a part or all of the inspection result record is also illustrated.

The description returns to the explanation for FIG. 26. The screen outputting unit 975 outputs the generated notification screen (S2605). For example, the screen outputting unit 975 causes the display device of the relay device 109 to display the notification screen thereon.

The compatibility inspecting unit 931 branches a process depending on whether compatibility inspecting unit 931 determines that the compatibility inspection processing is to end (S2607). For example, if a certain period of time has elapsed, the compatibility inspection processing is ended. Alternatively, the compatibility inspection processing may be ended when an end instruction is accepted.

If the compatibility inspecting unit 931 does not determine that the compatibility inspection processing is to end, the processing is returned to the process at S2001 illustrated in FIG. 20 via the terminal C. On the other hand, if the compatibility inspecting unit 931 determines that the compatibility inspection processing is to end, the compatibility inspection processing is ended, and the processing is recovered to the main processing that is a calling source.

The description returns to the explanation for FIG. 16. After the compatibility inspection processing is ended, the processing is returned to the process indicated at S1601, and waits for next timing.

With the present embodiment, it is possible to detect an upgrade in terms of the WebAPI to which an attention is to be paid.

The presence or absence of compatibility is determined based on a difference in the response contents, so that it is also possible to easily secure an operation in a program that utilizes the WebAPI.

When the difference does not fall within a prescribed exception type, it is determined that there is incompatibility, so that it is also possible to more practically inspect the compatibility.

### Second Embodiment

A relay unit that relays an HTTP message may be provided inside the API usage server 107, and the registration processing and the main processing described above may be performed in the relay unit.

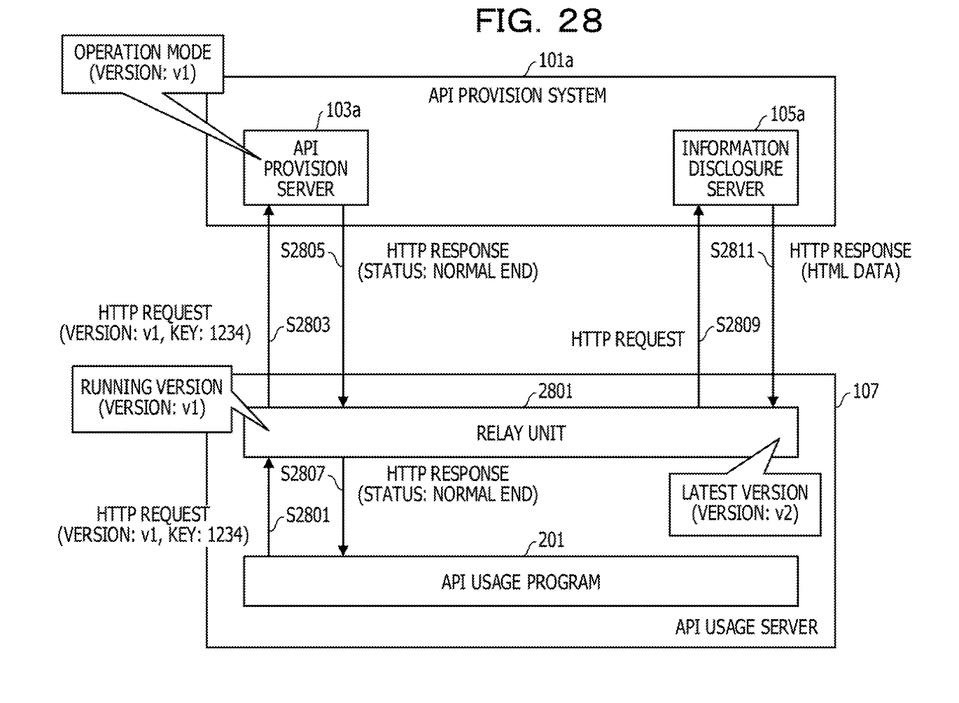

FIG. 28 illustrates an overview of version inspection in a second embodiment. Instead of the relay device 109 illustrated in FIG. 7, a relay unit 2801 included in the API usage server 107 internally transfers an HTTP request and an HTTP response.

The HTTP request explained at S301 illustrated in FIG. 3 is sent out via the relay unit 2801 (S2801, S2803). The HTTP response explained at S303 illustrated in FIG. 3 is accepted via the relay unit 2801 (S2805, S2807). Accordingly, the relay unit 2801 transfers data with the API usage server 107 by the internal communication. The relay unit 2801 transfers data with the outside via the LAN.

The relay unit 2801 includes the modules illustrated in FIGS. 9A and 9B, and performs processing similar to that in the case of the first embodiment. The HTTP request illustrated at S2809 is similar to that in the case of S709 illustrated in FIG. 7. The HTTP response illustrated at S2811 is similar to that in the case of S711 illustrated in FIG. 7.

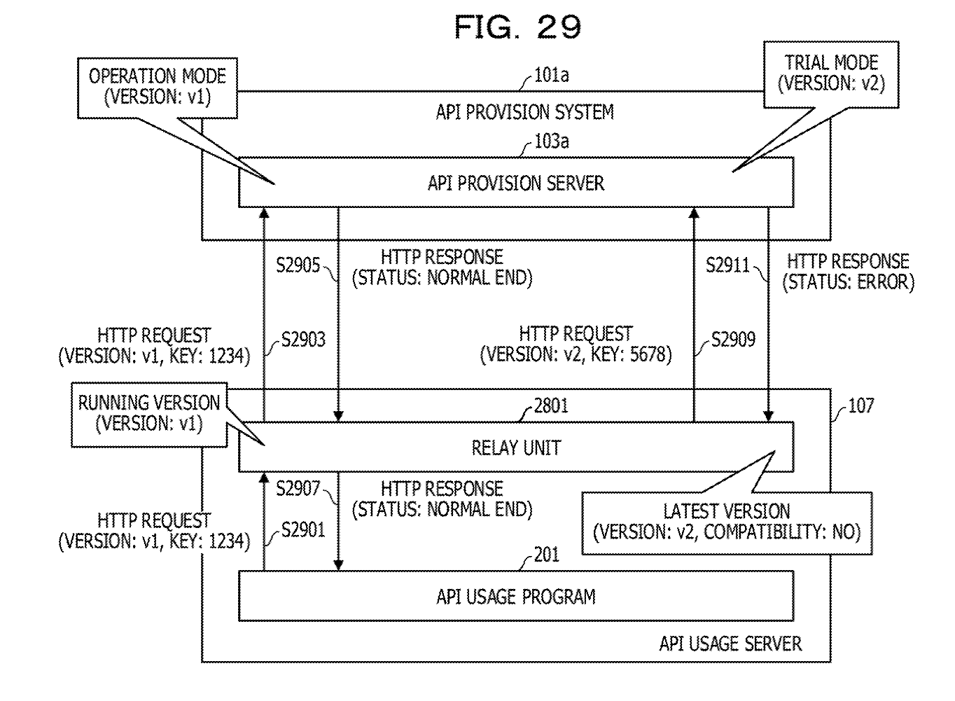

FIG. 29 illustrates an overview of compatibility inspection in the second embodiment. Also as for the compatibility inspection, the relay unit 2801 performs processing similar to that in the case of the first embodiment.

The HTTP request illustrated at S2901 is similar to that in the case of S801 illustrated in FIG. 8. The HTTP request illustrated at S2903 is similar to that in the case of S803 illustrated in FIG. 8.

The HTTP response illustrated at S2905 is similar to that in the case of S805 illustrated in FIG. 8. The HTTP response illustrated at S2907 is similar to that in the case of S807 illustrated in FIG. 8.

The HTTP request illustrated at 52909 is similar to that in the case of S809 illustrated in FIG. 8. The HTTP response illustrated at S2911 is similar to that in the case of S811 illustrated in FIG. 8.

With the present embodiment, it is possible to apply the present disclosure also to the configuration of a network including no relay device 109.

The Internet in the examples described above is an example of the network. For example, the Internet may be replaced with the intranet.

The embodiments have been explained in the foregoing; however, the present disclosure is not limited to thereto. For example, the abovementioned function block configuration does not match the program module configuration in some cases.

The configuration of each storage region explained in the foregoing is merely one example, and is not limited to the configuration as the above. Also in the processing flow, the order of the processes may preferably be interchanged or the multiple processes may preferably be executed in parallel with one another as long as the process result is not changed.

Note that, the relay device 109 described above is a computer device, as illustrated in FIG. 30, in which a memory 3001, the CPU 3003, a hard disk drive (HDD) 3005, a display control unit 3007 that is coupled a display device 3009, a drive device 3013 for a removable disk 3011, an input device 3015, a communication unit 3017a for connection to a network, and a communication unit 3017b for connection to a LAN are coupled to one another via a bus 3019. An operating system (OS) and an application program for conducting the processing in the embodiments are stored in the HDD 3005, and are read out into the memory 3001 from the HDD 3005 when being executed by the CPU 3003. The CPU 3003 controls and causes the display control unit 3007, the communication units 3017a and 3017b, and the drive device 3013 to perform required operations, if required. Note that, data that is inputted via either one of the communication units 3017a and 3017b is outputted via the other one of the communication units 3017a and 3017b. The CPU 3003 controls the communication units 3017a and 3017b to switch output destinations appropriately. Data in the middle of the processing is stored in the memory 3001, and is stored in the HDD 3005 if required. In the embodiments according to the present disclosure, the application program for conducting the processing described above is distributed by being stored in the computer-readable removable disk 3011, and is installed into the HDD 3005 from the drive device 3013. The application program for conducting the processing described above is installed into the HDD 3005 via either one of the communication units 3017a and 3017b in some cases. Such a computer device implements the various kinds of functions as described above in such a manner that the hardware such as the CPU 3003 and the memory 3001 and the OS are systematically cooperated with the application programs.

The API usage server 107 described above is a computer device, as illustrated in FIG. 31, in which a memory 3101, the CPU 3103, a hard disk drive 3105, a display control unit 3107 that is coupled to a display device 3109, a drive device 3113 for a removable disk 3111, an input device 3115, and a communication control unit 3117 for connection to a network are coupled to one another via a bus 3119. An operating system and an application program for conducting the processing in the embodiments are stored in the HDD 3105, and are read out into the memory 3101 from the HDD 3105 when being executed by the CPU 3103. The CPU 3103 controls the display control unit 3107, the communication control unit 3117, the drive device 3113 in accordance with the processing contents of the application program, and causes these units to perform predetermined operations. Although data in the middle of the processing is mainly stored in the memory 3101, the data may preferably be stored in the HDD 3105. In the embodiments according to the present disclosure, the application program for conducting the processing described above is distributed by being stored in the computer-readable removable disk 3111, and is installed into the HDD 3105 from the drive device 3113. The application program is installed into the HDD 3105 through a network such as the Internet and the communication control unit 3117 in some cases. Such a computer device implements the various kinds of functions as described above in such a manner that the hardware such as the CPU 3103 and the memory 3101 and the OS are systematically cooperated with the application programs.

The embodiments according to the present disclosure described in the foregoing are summarized as follows.

A change detection method executed by a relay computer that relays a request for utilizing a function that is provided via a network according to the present embodiments, and a response to the request, the change detection method including: (A) first determination processing of acquiring information on the latest version of the abovementioned function from a device that provides information on the abovementioned function, and determining whether a version extracted from the request matches the latest version; and (B) second determination processing of transmitting, when the extracted version does not match the latest version, a trial request in which the abovementioned request is modified so as to utilize the abovementioned function of the latest version, and determining whether there is compatibility between the version of the function utilized by the abovementioned request and the latest version, based on a response to the trial request.

In this manner, it is possible to detect a specification change that requires an attention in terms of a function provided via a network.

In addition, in the abovementioned second determination processing, whether there is compatibility may be determined based on a difference between the response to the abovementioned request and a response to the trial request.

In this manner, it is possible to secure an operation in a program that utilizes the function provided via the network.

In addition, in the abovementioned second determination processing, when the abovementioned difference does not fall within any of prescribed exception types, the determination of the incompatibility may be made.

In this manner, the compatibility may be more practically inspected.

Note that, a program to allow a computer to execute the processes by the abovementioned method may be created, and the program is stored in, for example, a computer readable storage medium such as a flexible disk, a CD-ROM, a magneto-optical disk, a semiconductor memory, or a hard disk, or a storage memory. Note that, a midway process result is temporarily kept in a storage memory such as a main memory in general.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A medium having stored therein a program for causing a computer to execute a process below, the process comprising:
receiving, from a second device, a request to a first device for utilizing a function provided via a network;
acquiring information on a latest version of the function from a device that provides information on the function;
determining whether a version of the function extracted from the request matches the latest version;
when the extracted version does not match the latest version, transmitting a trial request in which the request is modified so as to utilize the function of the latest version, to the first device; and
determining whether or not there is compatibility between the version of the function to be utilized by the request and the latest version based on a response to the trial request.

2. The medium according to claim 1, wherein whether or not there is compatibility is determined based on a difference between a response to the request and the response to the trial request.

3. The medium according to claim 2, wherein it is determined that there is incompatibility when the difference does not fall within a prescribed exception type.

4. A change detection method comprising:
receiving, from a second device, a request to a first device for utilizing a function provided via a network;
acquiring information on a latest version of the function from a device that provides information on the function;
determining whether a version of the function extracted from the request matches the latest version;
when the extracted version does not match the latest version, transmitting a trial request in which the request is modified so as to utilize the function of the latest version, to the first device; and
determining whether or not there is compatibility between the version of the function to be utilized by the request and the latest version based on a response to the trial request.

5. A change detection apparatus comprising:
a memory; and
a processor coupled to the memory and the processor configured to execute a process, the process including:
receiving, from a second device, a request to a first device for utilizing a function provided via a network;
acquiring information on a latest version of the function from a device that provides information on the function;
determining whether a version of the function extracted from the request matches the latest version;
when the extracted version does not match the latest version, transmitting a trial request in which the request is modified so as to utilize the function of the latest version, to the first device; and
determining whether or not there is compatibility between the version of the function to be utilized by the request and the latest version based on a response to the trial request.
